(19) United States
(12) Patent Application Publication
(10) Pub. No.: US 2026/0110957 A1
(43) Pub. Date: Apr. 23, 2026

(54) ELECTRONIC DEVICE AND PROJECTOR

(71) Applicant: SAMSUNG ELECTRONICS CO., LTD., Suwon-si (KR)

(72) Inventors: Jisu KIM, Suwon-si (KR); Hunsung KIM, Suwon-si (KR); Yousub LEE, Suwon-si (KR); Daesu CHOI, Suwon-si (KR); Daegun HONG, Suwon-si (KR)

(73) Assignee: SAMSUNG ELECTRONICS CO., LTD., Suwon-si (KR)

(21) Appl. No.: 19/310,254

(22) Filed: Aug. 26, 2025

Related U.S. Application Data
(63) Continuation of application No. PCT/KR2025/012335, filed on Aug. 14, 2025.

(30) Foreign Application Priority Data
Oct. 21, 2024 (KR) 10-2024-0144442

(51) Int. Cl. G03B 29/00; A47L 9/30; A47L 11/40; G03B 21/14

(52) U.S. Cl. CPC G03B 29/00; A47L 9/30; A47L 11/4072; G03B 21/145

(57) ABSTRACT

Provided is an electronic device including: a main body; first and second wheels rotatably attached to the main body, the first wheel being rotatable around a first rotation axis, the second wheel device including: a wheel cover rotatably connected to the main body and configured to rotate around a second rotation axis, wherein the second rotation axis extends in a direction intersecting a direction corresponding to the first rotation axis; a wheel shaft attached to the wheel cover and extending in a direction that intersects with the direction in which the second rotation axis extends; and a second wheel rotatably attached to the wheel shaft, wherein the second wheel includes a circumferential outer surface including a first portion and a second portion, wherein an outer diameter of at least a portion of the first portion is greater than an outer diameter of any portion of the second portion.

### CROSS-REFERENCE TO RELATED APPLICATIONS

This application is a by-pass continuation of International Application No. PCT/KR2025/012335, filed on Aug. 14, 2025, which is based on and claims priority to Korean Patent Application No. 10-2024-0144442, filed in the Korean Intellectual Property Office on Oct. 21, 2024, the disclosures of which are incorporated by reference herein in their entireties.

### BACKGROUND

### 1. Field

The present disclosure relates to an electronic device and a projector including an improved structure.

### 2. Description of Related Art

An electronic device may include a main body and a plurality of wheels configured to move the main body. With the configuration, the electronic device may be more easily moved within a space.

The plurality of wheels may include a main wheel configured to be rotated by a driving device including a motor, and an auxiliary wheel configured to movably support the main body together with the main wheel and configured to rotate as the main body moves.

The electronic device including the configuration described above may include a projector configured to be movable to project an image in an arbitrary area, and a robot cleaner configured to be movable to perform a cleaning function in an arbitrary location.

### SUMMARY

Provided is an electronic device including an auxiliary wheel having relatively fast responsiveness.

Further, provided is an electronic device capable of preventing foreign substances from being introduced into an inside of an auxiliary wheel.

Further, provided is an electronic device capable of removing foreign substances that are introduced into an auxiliary wheel.

Additional aspects of the disclosure will be set forth in part in the description which follows and, in part, will be apparent from the description, or may be learned by practice of the disclosure.

According to an aspect of the disclosure, an electronic device includes: a main body; a first wheel device configured to move the main body, the first wheel device including a first wheel rotatable with respect to a first rotation axis; and a second wheel device configured to movably support the main body, the second wheel device including: a wheel cover rotatable relative to the main body with respect to a second rotation axis, the second rotation axis extending in a direction intersecting the first rotation axis; a wheel shaft connected to the wheel cover and extending in one direction intersecting the second rotation axis; and a second wheel rotatable relative to a central axis of the wheel shaft, the second wheel including a first portion and a second portion distinguished based on an imaginary line extending in a radial direction of the wheel shaft and aligned with a center of the second wheel with respect to the one direction, wherein an outer diameter of at least a portion of the first portion is greater than an outer diameter of any portion of the second portion.

According to an aspect of the disclosure, an electronic device includes: a main body; a first wheel rotatably attached to the main body, wherein the first wheel is rotatable around a first rotation axis; and a second wheel device rotatably attached to the main body, the second wheel device including: a wheel cover rotatably connected to the main body and configured to rotate around a second rotation axis, wherein the second rotation axis extends in a direction intersecting a direction corresponding to the first rotation axis; a wheel shaft attached to the wheel cover and extending in a direction that intersects with the direction in which the second rotation axis extends; and a second wheel rotatably attached to the wheel shaft, wherein the second wheel includes a circumferential outer surface including a first portion and a second portion, wherein an outer diameter of at least a portion of the first portion is greater than an outer diameter of any portion of the second portion.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a perspective view of a projector according to one or more embodiments;

FIG. 2 is a rear perspective view of the projector according to one or more embodiments;

FIG. 3 is a view schematically illustrating a main body, a first wheel device, and a second wheel device according to an embodiment;

FIG. 4 is a top, perspective view illustrating the second wheel device according to an embodiment;

FIG. 5 is a bottom, perspective view illustrating the second wheel device according to an embodiment;

FIG. 6 is a cross-sectional view taken along line A-A′ of FIG. 4;

FIG. 7 is an exploded view of the second wheel device according to an embodiment;

FIG. 8 is an exploded view of the second wheel device according to an embodiment;

FIG. 9 is a side view illustrating a state in which the projector moves according to an embodiment;

FIG. 10 is an enlarged view of region D of FIG. 6;

FIG. 11 is a cross-sectional view taken along line B-B′ of FIG. 4;

FIG. 12 is an enlarged view of region E of FIG. 11;

FIG. 13 is a bottom view of the projector according to an embodiment;

FIG. 14 illustrates a state in which the projector of FIG. 13 changes a driving direction thereof;

FIG. 15 illustrates a state in which a second wheel cover and the second wheel of the second wheel device of FIG. 14 are rotated in response to the driving direction of the projector;

FIG. 16 is an enlarged view of region D of FIG. 6;

FIG. 17 is an enlarged view of region E of FIG. 11;

FIG. 18 is an enlarged view of region F of FIG. 16;

FIG. 19 is an enlarged view of region G of FIG. 16;

FIG. 20 is a cross-sectional view taken along line C-C′ of FIG. 3;

FIG. 21 is an enlarged cross-sectional view of a second wheel and a peripheral configuration thereof according to an embodiment;

FIG. 22 is a perspective view of a robot cleaner according to an embodiment; and

FIG. 23 is a bottom perspective view of the robot cleaner of FIG. 22.

### DETAILED DESCRIPTION

The various embodiments described herein, and the terms used to describe such embodiments, are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

The terms “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

The terms such as “unit”, “module”, and “member” may be embodied as hardware or software. According to embodiments, a plurality of “unit”, “module”, and “member” may be implemented as a single component or a single “unit”, “module”, and “member” may include a plurality of components.

In the following description, terms such as “unit”, “part”, “block”, “member”, and “module” may indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor

An identification code is used for the convenience of the description but is not intended to illustrate the order of each step. The each step may be implemented in the order different from the illustrated order unless the context clearly indicates otherwise.

In the following detailed description, the terms of “front”, “rear”, “left”, “right”, “upper”, “lower” and the like may be defined by the drawings, but the shape and the location of the element is not limited by the term. For example, the front may be defined as the +X side, and the rear may be defined as the −X side. For example, the left may be defined as the +Y side, and the right may be defined as the −Y side, based on the drawing. For example, the upper may be defined as the +Z side, and the lower may be defined as the −Z side, based on the drawing.

Hereinafter exemplary embodiments of the present disclosure will be described in detail with reference to the accompanying drawings.

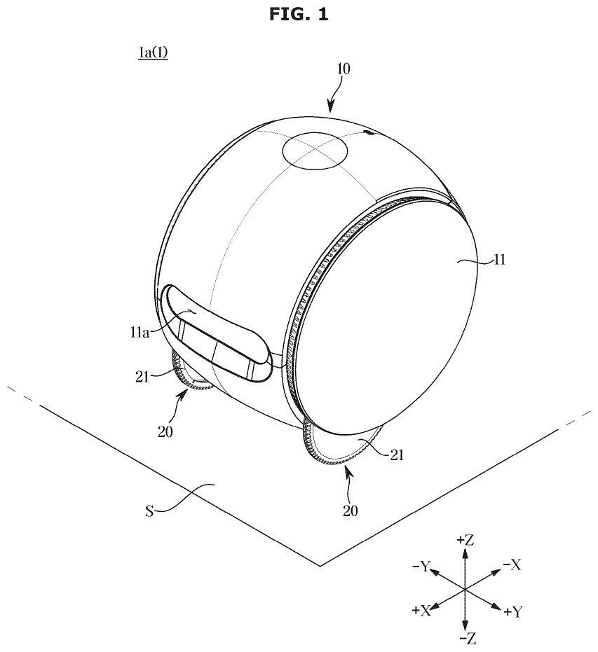

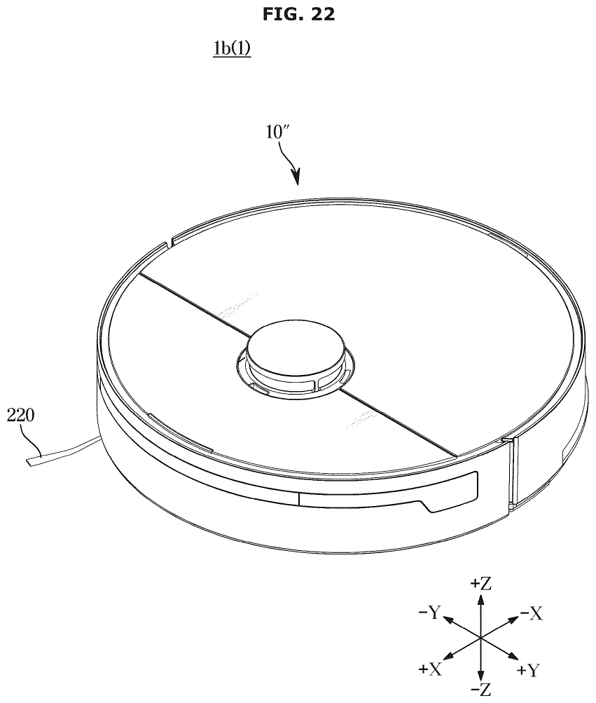

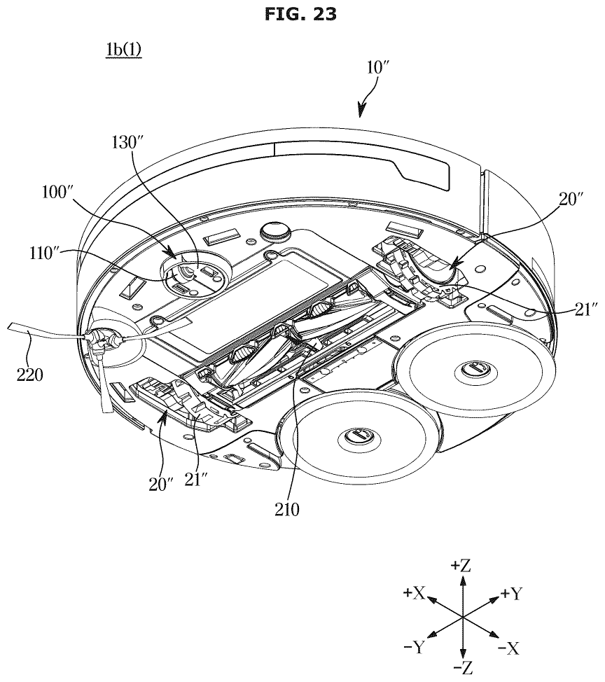

The present disclosure relates to an electronic device 1. The electronic device 1 according to the present disclosure may include a projector, a robot cleaner, and the like. In FIGS. 1 to 21, an example 1a of a projector may be described. In FIGS. 22 and 23, an example 1b of a robot cleaner may be described. However, the present disclosure is not limited thereto. For example, when it is an electronic device including a main body and a wheel device configured to move the main body on the floor, the electronic device may be included in the electronic device 1 according to the present disclosure.

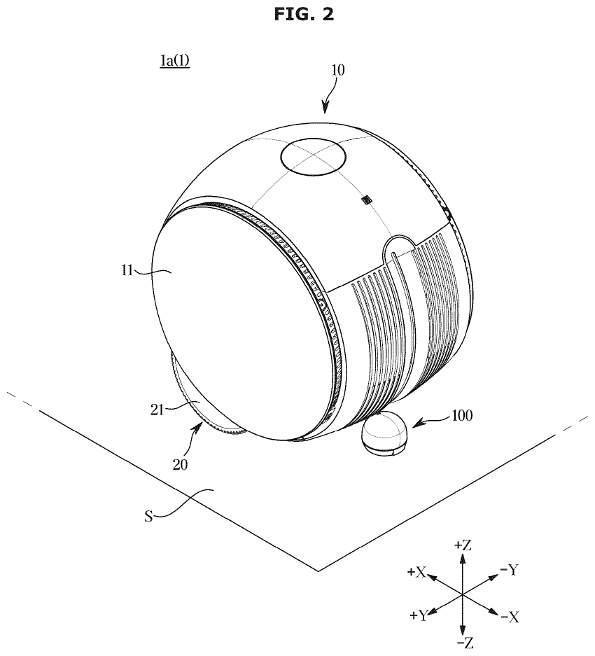

FIG. 1 is a perspective view of a projector according to an embodiment. FIG. 2 is a rear perspective view of the projector according to an embodiment.

The projector 1a may be a device configured to project an image. The image may include a photograph, a video, text, and the like.

Referring to FIGS. 1 and 2, the projector 1a may include a main body 10. The main body 10 may form an exterior of the projector 1a.

The main body 10 may include a light source configured to emit light, and a lens configured to receive light from the light source and form an image. The light source and lens may be provided inside the main body 10.

The main body 10 may include a housing 11. The housing 11 may form an exterior of the main body 10. In other words, the housing 11 may form the exterior of the projector 1a. A receiving space may be formed on the inside of the housing 11 to receive various components such as the light source or the lens. There is no particular limitation on the shape of the housing 11.

The housing 11 may include a housing opening 11a. The housing opening 11a may be provided to allow light emitted from the light source inside the main body 10 to be emitted to the outside of the main body 10. That is, the light emitted from the light source inside the main body 10 may pass through the housing opening 11a. An image formed by the lens inside the main body 10 may be projected onto an arbitrary area outside the main body 10.

For example, the housing opening 11a may be formed on a front surface of the housing 11. However, there is no particular limitation on the position at which the housing opening 11a is formed.

The projector 1a may include a first wheel device 20. The first wheel device 20 may be configured to move the main body 10. The first wheel device 20 may be configured to support the main body 10. That is, the first wheel device 20 may movably support the main body 10. The projector 1a may be configured to be movable on a floor S on which the projector 1a is placed. The first wheel device 20 may also be referred to as a main wheel device 20.

The first wheel device 20 may be provided at a lower portion of the main body 10. In other words, the first wheel device 20 may be provided at a lower portion of the housing 11.

The first wheel device 20 may be provided in plurality. For example, two first wheel devices 20 may be provided. One of the two first wheel devices 20 may be provided at a lower portion of one side of the main body 10, and the other first wheel device 20 may be provided at a lower portion of the other side of the main body 10. Particularly, one of the two first wheel devices 20 may be provided at a lower portion of the left side (+Y) of the main body 10, and the other first wheel device 20 may be provided at a lower portion of the right side (−Y) of the main body 10.

The first wheel device 20 may include a first wheel 21. The first wheel 21 may be configured to be rotatable. Particularly, the first wheel 21 may be rotatable with respect to the main body 10. The first wheel 21 may also be referred to as a main wheel 21.

As the first wheel 21 rotates, the main body 10 may move or change a driving direction thereof. In other words, as the first wheel 21 rotates, the projector 1a may move or change a driving direction thereof.

The first wheel 21 may be provided at the lower portion of the main body 10. In other words, the first wheel 21 may be provided at the lower portion of the housing 11.

As described above, the first wheel device 20 may be provided in plurality and thus the first wheel 21 may also be provided in plurality. For example, two first wheels 21 may be provided. One of the two first wheels 21 may be provided at the lower portion of one side of the main body 10, and the other first wheel 21 may be provided at the lower portion of the other side of the main body 10. Particularly, one of the two first wheels 21 may be provided at the lower portion of the left side (+Y) of the main body 10, and the other first wheel 21 may be provided at the lower portion of the right side (−Y) of the main body 10.

The projector 1a may include a second wheel device 100. The second wheel device 100 may be configured to move the main body 10. The second wheel device 100 may be configured to support the main body 10. That is, the second wheel device 100 may movably support the main body 10. Particularly, the second wheel device 100 may movably support the main body 10 together with the first wheel device 20. The projector 1a may be configured to be movable on the floor S. The second wheel device 100 may also be referred to as an auxiliary wheel device 20.

The second wheel device 100 may be provided at the lower portion of the main body 10. In other words, the second wheel device 100 may be provided at the lower portion of the housing 11. The second wheel device 100 may be provided behind the first wheel device 20.

In the drawing, it is illustrated that a single second wheel device 100 is provided, but there is no particular limitation on the number of second wheel devices 100. For example, two or more second wheel devices 100 may be provided.

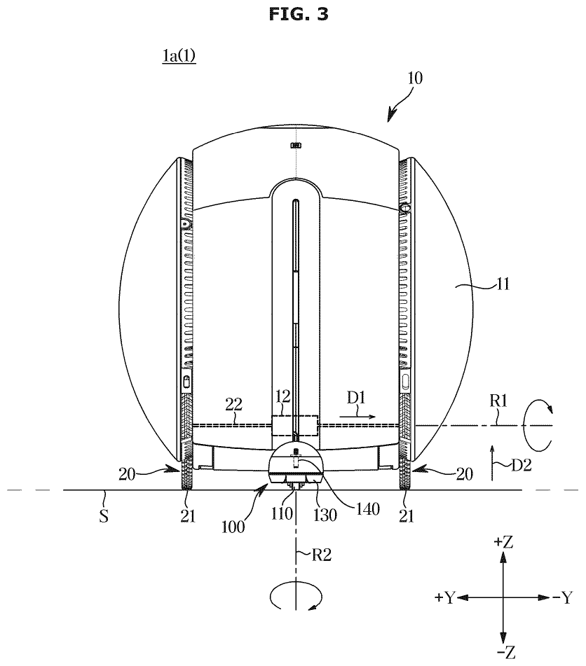

FIG. 3 is a view schematically illustrating a main body, a first wheel device, and a second wheel device according to an embodiment.

Referring to FIG. 3, the first wheel device 20 may include a first wheel shaft 22. The first wheel 21 may be rotatable with respect to a central axis of the first wheel shaft 22. The first wheel shaft 22 may also be referred to as a main wheel shaft 22.

The first wheel shaft 22 may be rotatably coupled to the first wheel 21. That is, the first wheel 21 may be rotatable with respect to the first wheel shaft 22. However, depending on embodiments, the first wheel shaft 22 and the first wheel 21 may be coupled so as not to be rotatable with respect to each other, and may be simultaneously rotatable with respect to the main body 10.

The first wheel shaft 22 may extend in a first direction D1. For example, the first wheel shaft 22 may extend in the left and right direction (Y-axis direction).

The central axis of the first wheel shaft 22 may form a first rotation axis R1 extending in the first direction D1. The first rotation axis R1 may be a rotation center of the first wheel 21. That is, the first wheel 21 may be rotatable with respect to the first rotation axis R1.

In FIG. 3, it is illustrated that a single first wheel shaft 22 is provided, but the number of first wheel shafts 22 is not limited thereto. For example, the first wheel device 20 may include two first wheel shafts 22 respectively coupled to two first wheels 21.

Alternatively, the first wheel shaft 22 may be omitted. For example, the first wheel 21 may be rotated by being coupled to a gear. However, even in this case, the first wheel 21 may be rotatable with respect to the first rotation axis R1. At this time, the first rotation axis R1 may be formed as an imaginary line.

The main body 10 may include a driving device 12. The driving device 12 may include a power source for transmitting power to other components. For example, the driving device 12 may include a motor.

The driving device 12 may be coupled to the first wheel shaft 22. The driving device 12 may transmit power to the first wheel shaft 22 to rotate the first wheel shaft 22. As the first wheel shaft 22 rotates, the first wheel 21 may also rotate. That is, the first wheel 21 may be configured to be rotated by the driving device 12.

In FIG. 3, it is illustrated that a single driving device 12 is provided, but the number of driving devices 12 is not limited thereto. For example, when two first wheel shafts 22 are provided, the main body 10 may include two driving devices 12 respectively coupled to the two first wheel shafts 22.

As described above, the first wheel shaft 22 may be omitted, and the first wheel 21 may be coupled to a gear and the like. At this time, the driving device 12 may be coupled to the gear to transmit power to the gear.

The second wheel device 100 may include a second wheel 110. The second wheel 110 may be configured to be rotatable.

The second wheel 110 may be configured to rotate as the main body 10 moves. In other words, the second wheel 110 may rotate without a separate driving device directly coupled thereto. That is, the driving direction or driving speed of the main body 10 may be determined by the first wheel 21 that rotates by the driving device 12, and the second wheel 110 may perform a function of assisting the first wheel 21 to allow the main body 10 to move smoothly. Therefore, the second wheel 110 may be referred to as an auxiliary wheel 110.

The second wheel device 100 may include a wheel cover 130. The wheel cover 130 may be provided to cover at least a portion of the second wheel 110.

The wheel cover 130 may be configured to be rotatable. Particularly, the wheel cover 130 may be rotatable with respect to the main body 10.

The wheel cover 130 may be rotatable with respect to a second rotation axis R2 extending in a second direction D2 intersecting the first rotation axis R1. In other words, the wheel cover 130 may be rotatable with respect to the second rotation axis R2 extending in the second direction D2 intersecting the first direction D1. For example, the second direction D2 may intersect the first rotation axis R1 perpendicularly. For example, the second direction D2 may intersect the first direction D1 perpendicularly. The second rotation axis R2 may be formed by a central axis of a connecting shaft 140 to be described later.

The second wheel 110 may be rotatable with respect to the wheel cover 130. That is, the wheel cover 130 may be rotatable with respect to the main body 10, and the second wheel 110 may be rotatable with respect to the wheel cover 130. A description of the rotation direction of the second wheel 110 will be described later.

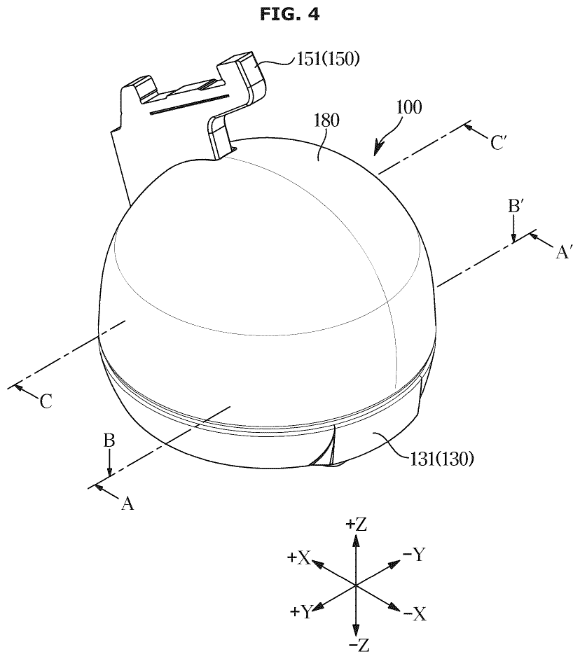

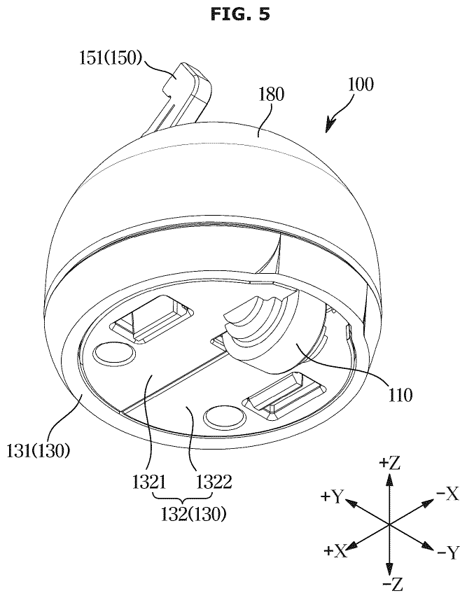

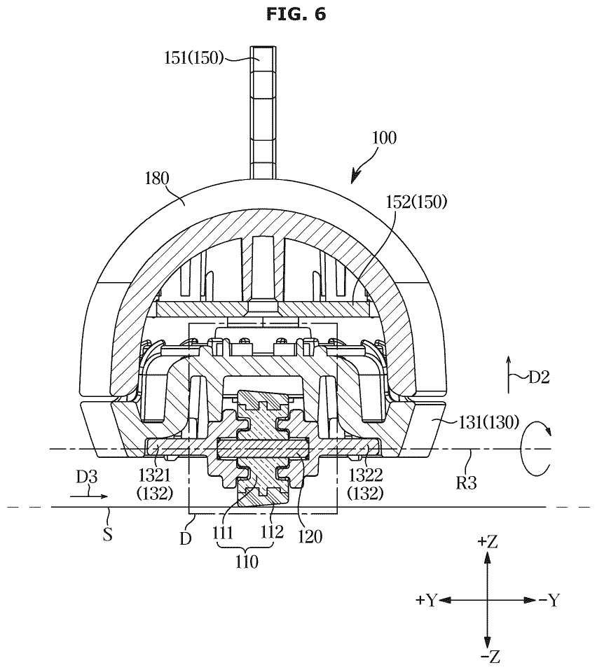

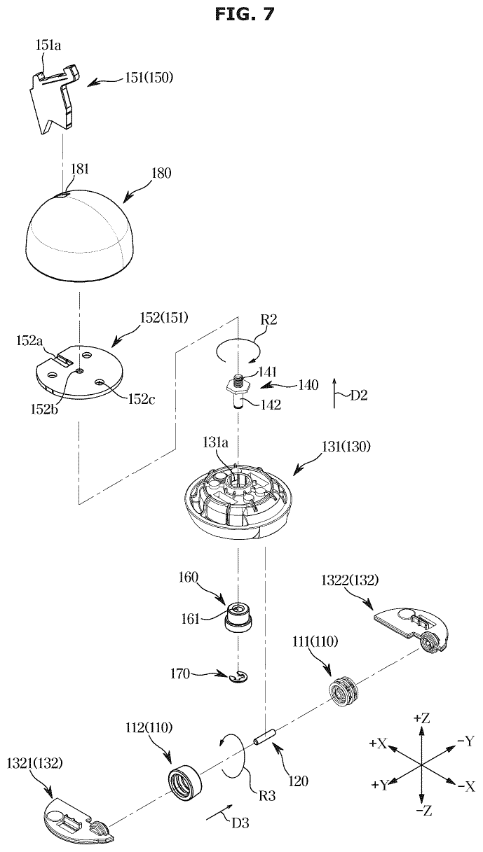

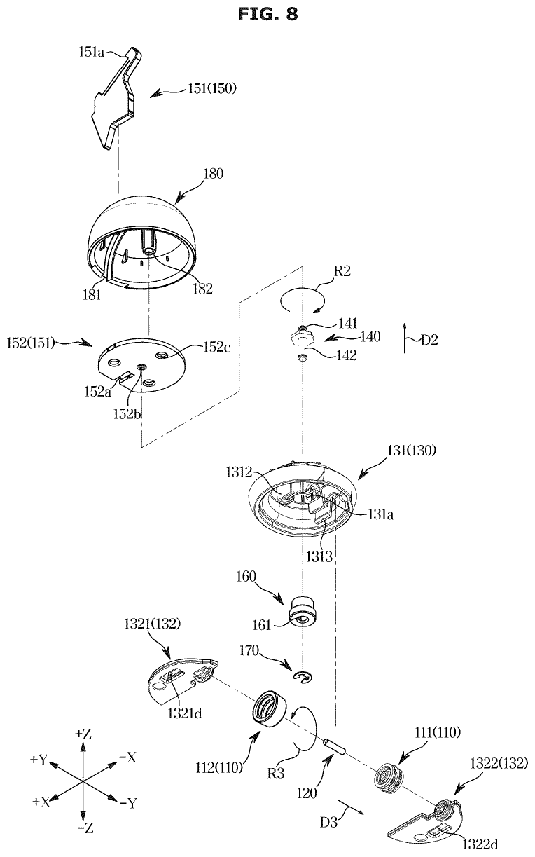

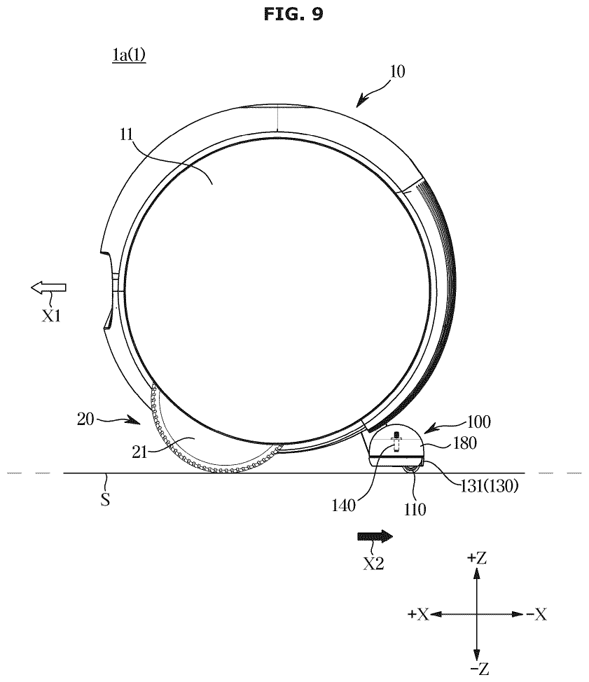

FIG. 4 is a view illustrating the second wheel device according to an embodiment. FIG. 5 is a view illustrating the second wheel device according to an embodiment. FIG. 6 is a cross-sectional view taken along line A-A′ illustrated in FIG. 4. FIG. 7 is an exploded view of the second wheel device according to an embodiment. FIG. 8 is an exploded view of the second wheel device according to an embodiment. FIG. 9 is a side view illustrates a state in which the projector moves according to an embodiment.

Referring to FIGS. 4 to 9, the second wheel device 100 may include the second wheel 110. The second wheel 110 may include an inner ring 111 and an outer ring 112.

The outer ring 112 may be arranged on an outer side (e.g., outer circumference) of the inner ring 111. The outer ring 112 may be coupled to the outer side of the inner ring 111.

The inner ring 111 may be rotatably coupled to a second wheel shaft 120 to be described later. As the outer ring 112 is coupled to the inner ring 111, the outer ring 112 may be rotatable with respect to the second wheel shaft 120.

At least a portion of the outer ring 112 may be provided to come into contact with the floor S on which the projector 1a is placed. For example, the outer ring 112 may include a rubber material.

The second wheel device 100 may include the second wheel shaft 120. The second wheel 110 may be rotatable with respect to a central axis of the second wheel shaft 120. The second wheel shaft 120 may also be referred to as an auxiliary wheel shaft 120.

The second wheel shaft 120 may be rotatably coupled to the second wheel 110. Particularly, the second wheel shaft 120 may be rotatably coupled to the inner ring 111 of the second wheel 110. That is, the second wheel 110 may be rotatable with respect to the second wheel shaft 120. In other words, the inner ring 111 and the outer ring 112 of the second wheel 110 may be rotatable with respect to the second wheel shaft 120. However, depending on embodiments, the second wheel shaft 120 and the second wheel 110 may be coupled so as not to be rotatable with respect to each other and may be simultaneously rotatable with respect to the wheel cover 130.

The second wheel shaft 120 may extend in a third direction D3. Particularly, the second wheel shaft 120 may extend in the third direction D3 intersecting the second rotation axis R2. In other words, the second wheel shaft 120 may extend in the third direction D3 intersecting the second direction D2. For example, the third direction D3 may intersect the second rotation axis R2 perpendicularly. For example, the third direction D3 may intersect the second direction D2 perpendicularly.

The second wheel shaft 120 may be provided in a substantially cylindrical shape. The central axis of the second wheel shaft 120 may form a third rotation axis R3 extending in the third direction D3.

The third rotation axis R3 may be a rotation center of the second wheel 110. That is, the second wheel 110 may be rotatable with respect to the third rotation axis R3.

The second wheel device 100 may include the wheel cover 130. The wheel cover 130 may be provided to cover at least a portion of the second wheel 110. Particularly, the wheel cover 130 may cover an upper portion of the second wheel 110.

The wheel cover 130 may be coupled to the second wheel shaft 120. In other words, the wheel cover 130 may support the second wheel shaft 120.

Particularly, the wheel cover 130 may be coupled to both ends of the second wheel shaft 120 with respect to the third direction D3. In other words, the wheel cover 130 may support both ends of the second wheel shaft 120 with respect to the third direction D3.

The wheel cover 130 may be rotatable with respect to the second rotation axis R2. In addition, because the wheel cover 130 is coupled to the second wheel shaft 120 and the second wheel shaft 120 is rotatably coupled to the second wheel 110, the second wheel shaft 120 and the second wheel 110 may be rotatable together with the wheel cover 130 with respect to the second rotation axis R2. This will be described in detail later.

The wheel cover 130 may include an upper cover 131 and a lower cover 132. The upper cover 131 and the lower cover 132 may be coupled to each other. A method, by which the upper cover 131 and the lower cover 132 are coupled, will be described later.

The upper cover 131 may be disposed on an upper side of the second wheel 110. The upper cover 131 may cover an upper portion of the second wheel 110. The upper cover 131 may form a receiving space for receiving the upper portion of the second wheel 110.

The lower cover 132 may be disposed on a lower side of the upper cover 131. The lower cover 132 may be coupled to the lower side of the upper cover 131. The lower cover 132 may cover a lower portion of the upper cover 131.

The lower cover 132 may be coupled to the second wheel shaft 120. In other words, the lower cover 132 may support the second wheel shaft 120.

Particularly, the lower cover 132 may be coupled to both ends of the second wheel shaft 120 with respect to the third direction D3. In other words, the lower cover 132 may support both ends of the second wheel shaft 120 with respect to the third direction D3.

The lower cover 132 may include a first lower cover 1321, and a second lower cover 1322. The first lower cover 1321 and the second lower cover 1322 may be arranged on either side of the second wheel 110 in the third direction D3.

The first lower cover 1321 may be coupled to one end of the second wheel shaft 120 with respect to the third direction D3, and the second lower cover 1322 may be coupled to the other end of the second wheel shaft 120 with respect to the third direction D3. In other words, the first lower cover 1321 may support one end of the second wheel shaft 120 with respect to the third direction D3, and the second lower cover 1322 may support the other end of the second wheel shaft 120 with respect to the third direction D3.

The second wheel device 100 may include a coupling bracket 150. The coupling bracket 150 may be provided to be coupled to the main body 10. As the coupling bracket 150 is coupled to the main body 10, the second wheel device 100 may be fixed to the main body 10.

The coupling bracket 150 may be connected to the wheel cover 130. As the coupling bracket 150 is coupled to the main body 10 and connected to the wheel cover 130, the second wheel device 100 may be connected to the main body 10.

The coupling bracket 150 may be disposed on an upper side of the wheel cover 130. Particularly, the coupling bracket 150 may be disposed on an upper side of the upper cover 131 of the wheel cover 130.

The coupling bracket 150 may include a first bracket 151, and a second bracket 152. The first bracket 151 may be coupled to an upper side of the second bracket 152. For example, at least a portion of a lower portion of the first bracket 151 may be inserted into a bracket groove 152a formed in the second bracket 152, and thus the first bracket 151 may be coupled to the upper side of the second bracket 152. However, the coupling method of the first bracket 151 and the second bracket 152 is not limited thereto.

The first bracket 151 may be provided to be coupled to the main body 10. For example, a main body coupling portion 151a provided to be coupled to at least a portion of the main body 10 may be provided on an upper portion of the first bracket 151. The first bracket 151 may be fixed to the main body 10 by being coupled to the main body 10.

The second bracket 152 may be provided to be connected to the wheel cover 130. The second bracket 152 may be connected to the wheel cover 130 and the first bracket 151 may be coupled to the main body 10. Accordingly, the second wheel device 100 may be connected to the main body 10. A description of the method by which the second bracket 152 is connected to the wheel cover 130 will be described later.

The second bracket 152 may be provided in a substantially plate shape. However, there is no particular limitation on the shape of the second bracket 152.

The second wheel device 100 may include a connecting shaft 140. The connecting shaft 140 may be provided to connect the coupling bracket 150 and the wheel cover 130. In other words, the connecting shaft 140 may be provided to connect the second bracket 152 and the wheel cover 130.

The connecting shaft 140 may extend in the second direction D2. Particularly, the connecting shaft 140 may extend in the second direction D2 intersecting the first rotation axis R1 (refer to FIG. 3). In other words, the connecting shaft 140 may extend in the second direction D2 intersecting the first direction D1 (refer to FIG. 3). In addition, the connecting shaft 140 may extend in the second direction D2 intersecting the third rotation axis R3. In other words, the connecting shaft 140 may extend in the second direction D2 intersecting the third direction D3. For example, the connecting shaft 140 may extend in the up and down direction.

The connecting shaft 140 may be provided in a substantially cylindrical shape. A central axis of the connecting shaft 140 may form the second rotation axis R2 extending in the second direction D2. For example, the central axis of the connecting shaft 140 may form the second rotation axis R2 extending in the up and down direction. Accordingly, the wheel cover 130 may rotate with respect to the second rotation axis R2 formed by the connecting shaft 140. In other words, the wheel cover 130 may rotate with respect to the connecting shaft 140.

A first through-hole 152b may be provided in the coupling bracket 150, and a second through-hole 131a may be provided in the wheel cover 130. Particularly, the first through-hole 152b may be provided in the second bracket 152, and the second through-hole 131a may be provided in the upper cover 131. The connecting shaft 140 may connect the coupling bracket 150 and the wheel cover 130 by penetrating the first through-hole 152b and the second through-hole 131a.

The connecting shaft 140 may include a first through-hole insertion portion 141. The first through-hole insertion portion 141 may be inserted into the first through-hole 152b. The first through-hole insertion portion 141 may be inserted into the first through-hole 152b and fixed to the coupling bracket 150. Particularly, the first through-hole insertion portion 141 may be inserted into the first through-hole 152b and fixed to the second bracket 152. For example, the first through-hole insertion portion 141 may be provided with screw threads, and the first through-hole insertion portion 141 may be inserted and fastened into the first through-hole 152b. Accordingly, the first through-hole insertion portion 141 may be fixed. With the configuration, the coupling bracket 150 may be limited in rotation with respect to the connecting shaft 140.

The connecting shaft 140 may include a second through-hole insertion portion 142. The second through-hole insertion portion 142 may be inserted into the second through-hole 131a. By inserting the second through-hole insertion portion 142 into the second through-hole 131a, the wheel cover 130 may be rotatable with respect to the second through-hole insertion portion 142. That is, the wheel cover 130 may be rotatable with respect to the connecting shaft 140. In addition, the first through-hole insertion portion 141 of the connecting shaft 140 may be fixed to the coupling bracket 150, and the coupling bracket 150 may be fixed to the main body 10. Accordingly, the wheel cover 130 may be rotatable with respect to the main body 10.

The second wheel shaft 120 may be provided at an eccentric position from the central axis of the connecting shaft 140 (refer to FIG. 9). In other words, the second wheel shaft 120 may be spaced apart or offset from the central axis of the connecting shaft 140. When the wheel cover 130 rotates with respect to the connecting shaft 140, the second wheel 110 may also rotate with respect to the connecting shaft 140. In other words, when the wheel cover 130 rotates with respect to the connecting shaft 140, the second wheel 110 may rotate with respect to the second rotation axis R2.

That is, the second wheel 110 may rotate with respect to the connecting shaft 140 regardless of rotating with respect to the second wheel shaft 120. In other words, the second wheel 110 may rotate with respect to the second rotation axis R2 regardless of rotating with respect to the third rotation axis R3.

The second wheel device 100 may include a bushing 160. The bushing 160 may be coupled to an inside of the second through-hole 131a of the upper cover 131. For example, the bushing 160 may be press-fitted into the inside of the second through-hole 131a.

A bushing hole 161 may be formed on an inside of the bushing 160. The bushing hole 161 may be formed at a position corresponding to the second through-hole 131a.

The connecting shaft 140 may be inserted into the bushing hole 161. In other words, the second through-hole insertion portion 142 may be inserted into the bushing hole 161. That is, as the second through-hole insertion portion 142 is inserted into the bushing hole 161, the second through-hole insertion portion 142 may be inserted into the second through-hole 131a.

An inner surface of the bushing hole 161 may be provided relatively smoothly. In addition, an outer surface of the second through-hole insertion portion 142 may be provided relatively smoothly. When the second through-hole insertion portion 142 is inserted into the bushing hole 161, the wheel cover 130 may rotate smoothly with respect to the second through-hole insertion portion 142. In other words, the wheel cover 130 may rotate smoothly with respect to the connecting shaft 140.

However, the bushing 160 may be replaced with another configuration that performs the same function. For example, the bushing 160 may be replaced with a bearing.

The second wheel device 100 may include a connecting shaft fixing portion 170. The connecting shaft fixing portion 170 may fix the lower end portion of the connecting shaft 140. At the lower side of the upper cover 131, the connecting shaft fixing portion 170 may fix the connecting shaft 140. In other words, at a lower side of the bushing 160, the connecting shaft fixing portion 170 may fix the connecting shaft 140. For example, the connecting shaft fixing portion 170 may be provided with an E-ring. The connecting shaft fixing portion 170 may prevent the connecting shaft 140 from being separated from the second through-hole insertion portion 142 or the bushing hole 161.

The second wheel device 100 may include a wheel cap 180. The wheel cap 180 may be positioned on the upper side of the wheel cover 130. The wheel cap 180 may cover the upper portion of the wheel cover 130. This configuration makes it less likely that the components of the wheel device 100 will be exposed to a user.

The wheel cap 180 may be provided in a hollow hemispherical shape. In other words, the wheel cap 180 may be provided in a dome shape. However, there is no particular limitation on the shape of the wheel cap 180.

The wheel cap 180 may be coupled to the coupling bracket 150. Particularly, the wheel cap 180 may include a cap groove 181 into which the first bracket 151 is inserted. In addition, the wheel cap 180 may include a fastening member insertion groove 182, the second bracket 152 may include a fastening member insertion hole 152c, and a separate fastening member may be inserted into and fastened to the fastening member insertion hole 152c of the second bracket 152 and the fastening member insertion groove 182 of the wheel cap 180. As a result of this configuration, the wheel cap 180 may be coupled to the coupling bracket 150.

At least a portion of the coupling bracket 150 may be disposed between the wheel cap 180 and the wheel cover 130. Particularly, the second bracket 152 may be disposed between the wheel cap 180 and the wheel cover 130.

Hereinafter the position of the second wheel 110 when the projector 1a drives in one direction will be described with reference to FIG. 9.

Referring to FIG. 9, when the projector 1a drives in one direction, the second wheel 110 may be positioned in a direction X2 opposite to a driving direction X1 of the projector 1a from the connecting shaft 140. For example, when the projector 1a drives in the +X direction, the second wheel 110 may be positioned in the −X direction from the connecting shaft 140. As a result, the first rotation axis R1, which is the rotation center of the first wheel 21, and the third rotation axis R3, which is the rotation center of the second wheel 110, may be provided in parallel to each other, and the projector 1a may drive stably.

When the projector 1a changes the driving direction X1, the second wheel 110 may not be positioned in a direction opposite to the changed driving direction of the projector 1a from the connecting shaft 140. In this case, the first rotation axis R1, which is the rotation center of the first wheel 21, and the third rotation axis R3, which is the rotation center of the second wheel 110, are not provided in parallel to each other. Accordingly, the projector 1a may shake and drive unstably. Therefore, when the projector 1a changes the driving direction X1, the second wheel 110 needs to rotate quickly with respect to the connecting shaft 140 so as to be positioned in the direction X2 opposite to the driving direction X1 of the projector 1a.

At this time, as the projector 1a changes the driving direction X1, the rotation of the second wheel 110 with respect to the connecting shaft 140 may be referred to as responsiveness of the second wheel 110. The faster the responsiveness of the second wheel 110, the more the driving stability of the projector 1a may be improved.

Hereinafter the structure of the second wheel 110 will be described in more detail, and a method for improving the responsiveness of the second wheel 110 will be described.

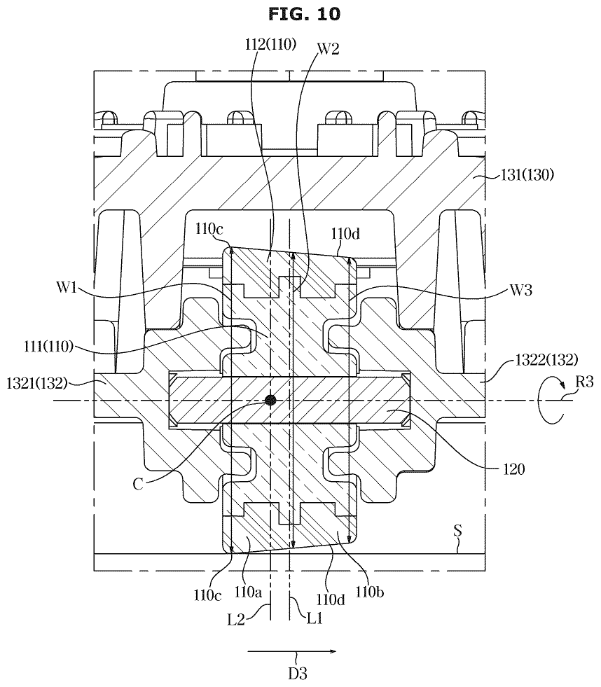

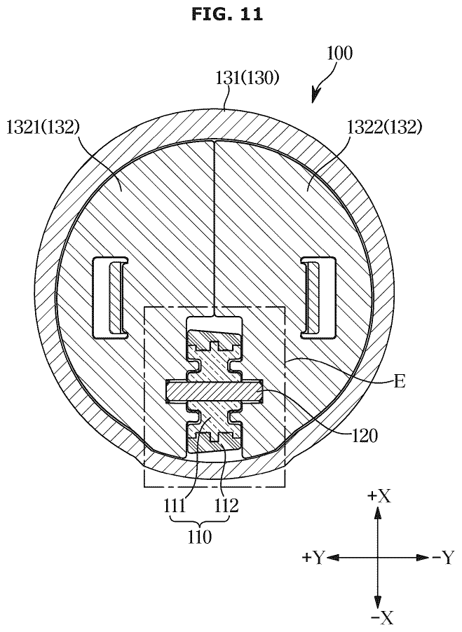

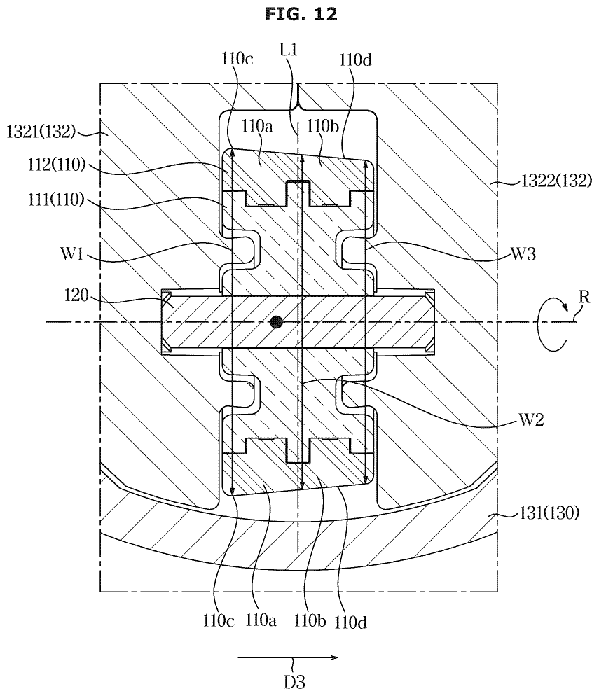

FIG. 10 is an enlarged view of a region D of FIG. 6. FIG. 11 is a cross-sectional view taken along line B-B′ of FIG. 4. FIG. 12 is an enlarged view of a region E of FIG. 11.

Referring to FIGS. 10 to 12, the projector 1a may be configured to be movable on the floor S. As the projector 1a moves on the floor S, the second wheel 110 may rotate with respect to the second wheel shaft 120.

The second wheel 110 may include an outer circumferential surface, and an inner circumferential surface. The outer circumferential surface of the second wheel 110 may refer to an outer surface of the second wheel 110 with respect to a radial direction of the second wheel shaft 120, and the inner circumferential surface of the second wheel 110 may refer to an inner surface of the second wheel 110 with respect to the radial direction of the second wheel shaft 120. In addition, the outer circumferential surface of the second wheel 110 may refer to an outer circumferential surface of the outer ring 112, and the inner circumferential surface of the second wheel 110 may refer to an inner circumferential surface of the inner ring 111. In this case, the radial direction of the second wheel shaft 120 may be a direction from the central axis of the second wheel shaft 120 toward the outer circumferential surface of the second wheel shaft 120.

An outer circumferential surface of at least a portion of the second wheel 110 may come into contact with the floor S as the second wheel 110 rotates. In other words, an outer circumferential surface of at least a portion of the outer ring 112 may come into contact with the floor S.

The inner circumferential surface of the second wheel 110 may be arranged to face the outer circumferential surface of the second wheel shaft 120. In other words, the inner circumferential surface of the inner ring 111 may be arranged to face the outer circumferential surface of the second wheel shaft 120.

The second wheel 110 may include a first portion 110a and a second portion 110b that are distinguished based on the center of the second wheel 110 with respect to the third direction D3. Particularly, the first portion 110a and the second portion 110b may be distinguished based on an imaginary line L1 that extends to the radial direction of the second wheel shaft 120 from the center of the second wheel 110 with respect to the third direction D3. Accordingly, one end of the second wheel 110 with respect to the third direction D3 may be provided in the first portion 110a, and the other end of the second wheel 110 with respect to the third direction D3 may be provided in the second portion 110b.

An outer diameter of at least a portion of the first portion 110a may be greater than an outer diameter of the second portion 110b. Particularly, the outer diameter of the at least a portion of the first portion 110a may be greater than an outer diameter W2 provided to be the longest in the second portion 110b. In other words, a distance, at which the outer circumferential surface of the at least a portion of the first portion 110a is spaced apart from the second wheel shaft 120 in the radial direction of the second wheel shaft 120, may be greater than a distance, at which the outer circumferential surface of the second portion 110b is spaced apart from the second wheel shaft 120 in the radial direction of the second wheel shaft 120.

The first portion 110a may include a contact portion 110c provided to come into contact with the floor S as the second wheel 110 rotates. The contact portion 110c may be provided on the outer circumferential surface of the second wheel 110.

An outer diameter W1 measured at a portion where the contact portion 110c is provided may be greater than the outer diameter of the second portion 110b. Particularly, the outer diameter W1 measured at the portion where the contact portion 110c is provided may be greater than the outer diameter W2 that is the longest in the second portion 110b. The outer diameter W1 measured at the portion where the contact portion 110c is provided may be greater than the outer diameter of any portion of the second portion 110b. In other words, a distance at which the contact portion 110c is spaced apart from the second wheel shaft 120 in the radial direction of the second wheel shaft 120 may be greater than a distance at which the outer circumferential surface of the second portion 110b is spaced apart from the second wheel shaft 120 in the radial direction of the second wheel shaft 120.

In addition, the outer diameter W1 of the second wheel 110 measured at the portion where the contact portion 110c is provided may be greater than an outer diameter measured at any other portion of the second wheel 110 except for the contact portion 110c. In other words, a distance at which the contact portion 110c is spaced apart from the second wheel shaft 120 in the radial direction of the second wheel shaft 120 may be greater than a distance at which any other portion of the second wheel 110 except for the contact portion 110c is spaced apart from the second wheel shaft 120 in the radial direction of the second wheel shaft 120. Put another way, a portion of the second wheel 110 that comes into contact with the floor S may be provided to be biased to one side with respect to the third direction D3.

The contact portion 110c may be provided at one end of the second wheel 110 with respect to the third direction D3. Particularly, the contact portion 110c may be provided on an outer circumferential surface of one end (e.g., a first end) of the second wheel 110 with respect to the third direction D3. However, a position where the contact portion 110c is formed is not limited thereto. For example, the contact portion 110c may be provided between the one end of the second wheel 110 with respect to the third direction D3 and the center of the second wheel 110 with respect to the third direction D3.

The contact portion 110c may be formed along a circumferential direction of the second wheel 110. That is, the contact portion 110c may be an outer circumferential surface of a portion having the longest diameter in the second wheel 110.

The contact portion 110c may be provided as a microscopic area. However, the disclosure is not limited thereto, and the contact portion 110c may be provided to extend in the third direction D3. A description thereof will be described later.

An inclined portion 110d may be provided in an outer circumferential surface of at least a portion of the second wheel 110. The inclined portion 110d may extend from the contact portion 110c toward the second portion 110b. In other words, the contact portion 110c may be formed on one side of the inclined portion 110d.

The inclined portion 110d may extend in an inclined direction with respect to the second wheel shaft 120. Particularly, the inclined portion 110d may be inclined in a direction opposite to the radial direction of the second wheel shaft 120. In other words, the inclined portion 110d may be inclined in a direction approaching the second wheel shaft 120 from the contact portion 110c.

The inclined portion 110d may extend to the other end of the second wheel 110 with respect to the third direction D3. The contact portion 110c may be provided at one end of the second wheel 110 with respect to the third direction D3, and the inclined portion 110d may extend from the contact portion 110c. Accordingly, the inclined portion 110d may extend from one end of the second wheel 110 to the other end of the second wheel 110 with respect to the third direction D3.

Accordingly, the outer circumferential surface of the second portion 110b may be provided as the inclined portion 110d. Because the inclined portion 110d is inclined in a direction approaching the second wheel shaft 120 from the contact portion 110c, the outer diameter W2 provided to be the longest in the second portion 110b may be an outer diameter W2 at a portion that is the closest to the center of the second wheel 110 with respect to the third direction D3.

As described above, the outer diameter of the at least a portion of the first portion 110a may be greater than the outer diameter W2 that is the longest in the second portion 110b. Particularly, the outer diameter W1 measured at the portion where the contact portion 110c is provided may be greater than the outer diameter W2 of the portion, which is the closest to the center of the second wheel 110 with respect to the third direction D3, in the second portion 110b. In other words, a distance, at which the outer circumferential surface of the one end of the second wheel 110 with respect to the third direction D3 is spaced apart from the second wheel shaft 120 in the radial direction of the second wheel shaft 120, may be greater than a distance at which the portion, which is the closest to the center of the second wheel 110 with respect to the third direction D3, in the second portion 110b is spaced apart from the second wheel shaft 120 in the radial direction of the second wheel shaft 120.

In addition, the outer diameter W1 of one end of the second wheel 110 with respect to the third direction D3 may be greater than an outer diameter W3 of the other end of the second wheel 110 with respect to the third direction D3. In other words, a distance at which an outer circumferential surface of the one end of the second wheel 110 with respect to the third direction D3 is spaced from the second wheel shaft 120 in the radial direction of the second wheel shaft 120 may be greater than a distance at which an outer circumferential surface of the other end of the second wheel 110 with respect to the third direction D3 is spaced from the second wheel shaft 120 in the radial direction of the second wheel shaft 120.

The inclined portion 110d may be formed along the circumferential direction of the second wheel 110. Due to the configuration, the exterior of the second wheel 110 may be provided in a substantially truncated cone shape.

According to the present disclosure, the contact portion 110c, which is a portion of the second wheel 110 that comes into contact with the floor S, may be provided to be biased to one side with respect to the third direction D3. In addition, the inclined portion 110d may be provided on one side of the contact portion 110c and may be spaced apart from the floor S.

A center of gravity C of the second wheel 110 may be located at a position that deviates from an imaginary area extending vertically from a portion in which the second wheel 110 comes into contact with the floor S. In addition, when considering that the second wheel shaft 120 is provided substantially parallel to the floor S, the contact portion 110c may not be provided in the radial direction of the second wheel shaft 120 from the center of gravity C of the second wheel 110, but the inclined portion 110d may be provided in the radial direction of the second wheel shaft 120 from the center of gravity C of the second wheel 110. In other words, an imaginary line L2 extending in the radial direction of the second wheel shaft 120 from the center of gravity C of the second wheel 110 may intersect the inclined portion 110d rather than the contact portion 110c.

The inclined portion 110d may be spaced apart from the floor S and provided in the radial direction of the second wheel shaft 120 from the center of gravity C of the second wheel 110. Accordingly, the second wheel 110 may be slightly inclined toward the inclined portion 110d. As the second wheel 110 is inclined toward the inclined portion 110d, the second wheel 110 may press the wheel cover 130 in one direction. For example, the third direction D3 may be a direction from the first portion 110a toward the second portion 110b, and the second wheel 110 may press the wheel cover 130 in the third direction D3.

At this time, the wheel cover 130 may rotate with respect to the connecting shaft 140, and thus torque may be applied to the wheel cover 130 by a force with which the second wheel 110 presses the wheel cover 130. That is, due to the above-described structure of the second wheel 110, a tendency in which the wheel cover 130 rotates with respect to the connecting shaft 140 may become stronger. Accordingly, when the projector 1a changes the driving direction thereof, the wheel cover 130 and the second wheel 110 may rotate more quickly to be positioned in the direction opposite to the driving direction of the projector 1a. That is, the responsiveness of the second wheel 110 may become relatively faster.

In addition, because the second wheel 110 is biased in only one direction, the rotation direction of the wheel cover 130 and the second wheel 110 may be limited to a direction from the first portion 110a to the second portion 110b with respect to the second rotation axis R2.

However, the above-mentioned effect is not only implemented when the second wheel 110 includes the inclined portion 110d. Particularly, when an outer diameter of at least a portion of the first portion 110a is greater than the outer diameter of the second portion 110b, the second wheel 110 may be provided to be inclined to one side, thereby implementing the above-described effect. For example, even when the second wheel 110 includes a stepped portion that is provided on one side of the contact portion 110c and formed to be stepped from the contact portion 110c, the above-mentioned effect may be implemented.

In addition, according to the present disclosure, the second wheel 110 may be provided asymmetrically with respect to an imaginary line L1 extending in the radial direction of the second wheel shaft 120 from the center of the second wheel 110 with respect to the third direction D3. Accordingly, the center of gravity C of the second wheel 110 may be provided at an eccentric (or offset) position from the center of the second wheel shaft 120 with respect to the third direction D3. Particularly, the center of gravity C of the second wheel 110 may be eccentric toward the first portion 110a as the first portion 110a has a relatively large volume compared to second portion 110b. In view of this configuration, when the projector 1a drives on the floor S, the first rotation axis R1, which is the rotation center of the first wheel 21, and the second rotation axis R2, which is the rotation center of the second wheel 110, may not be provided completely parallel to each other, but may be provided to be slightly inclined with respect to each other. A description thereof will be provided later.

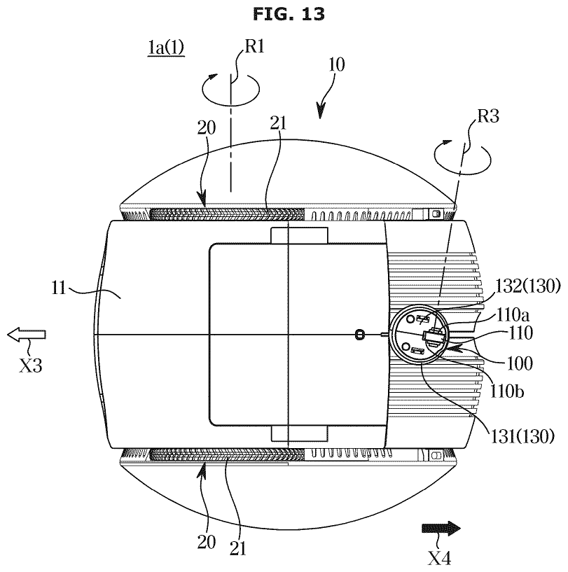

Hereinafter an example of the rotation of the second wheel 110 and the wheel cover 130 when the projector 1a changes the driving direction thereof will be described with reference to FIGS. 13 to 15.

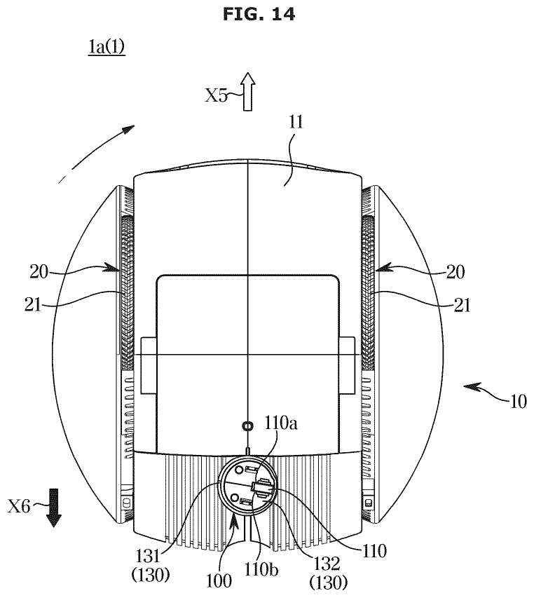

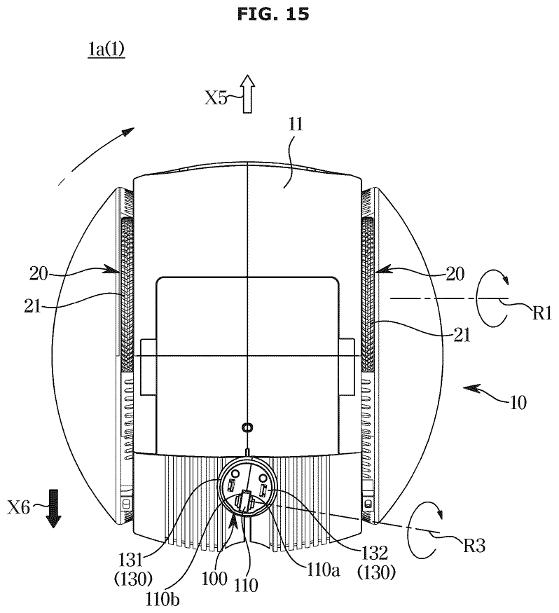

FIG. 13 is a bottom view of the projector according to an embodiment. FIG. 14 illustrates a state in which the projector of FIG. 13 changes a driving direction thereof. FIG. 15 illustrates a state in which a second wheel cover and the second wheel of the second wheel device of FIG. 14 is rotated in response to the driving direction of the projector.

Referring to FIGS. 13 to 15, the projector 1a may drive in a state in which the first rotation axis R1, which is the rotation center of the first wheel 21, and the third rotation axis R3, which is the rotation center of the second wheel 110, are not parallel to each other but are slightly inclined with respect to each other. This is because the center of gravity C of the second wheel 110 is eccentric (or offset) toward the first portion 110a (refer to FIG. 10). Accordingly, when the projector 1a drives, the second wheel 110 and the wheel cover 130 may maintain a state of slightly rotating in a direction from the first portion 110a toward the second portion 110b with respect to the second rotation axis R2 (refer to FIG. 3).

Referring to FIG. 13, the projector 1a may drive in a first driving direction X3. At this time, the second wheel 110 may be positioned in a direction X4 opposite to the first driving direction X3 from the connecting shaft 140.

Referring to FIG. 14, the projector 1a may change the driving direction by the first wheel 21. Particularly, the projector 1a may drive in a second driving direction X5, which is a direction rotated 90 degrees clockwise based on FIG. 14. At this time, the second wheel 110 may not be positioned in a direction X6 opposite to the second driving direction X5 from the connecting shaft 140. For example, the second wheel 110 may be positioned in a direction intersecting the second driving direction X5 from the connecting shaft 140.

Referring to FIG. 15, when the projector 1a drives in the second driving direction X5, the wheel cover 130 and the second wheel 110 may quickly rotate in one direction due to the inclined structure of the second wheel 110. Particularly, the wheel cover 130 and the second wheel 110 may rotate in a direction from the first portion 110a toward the second portion 110b with respect to the second rotation axis R2 (refer to FIG. 3).

When the second wheel 110 is positioned in the direction X6 opposite to the second driving direction X5 with respect to the connecting shaft 140, the second wheel 110 may no longer rotate with respect to the connecting shaft 140. This is because, when the second wheel 110 slightly deviates from the above-mentioned position, a frictional force may act on the second wheel 110 in the direction X6 opposite to the driving direction X5 of the projector 1a.

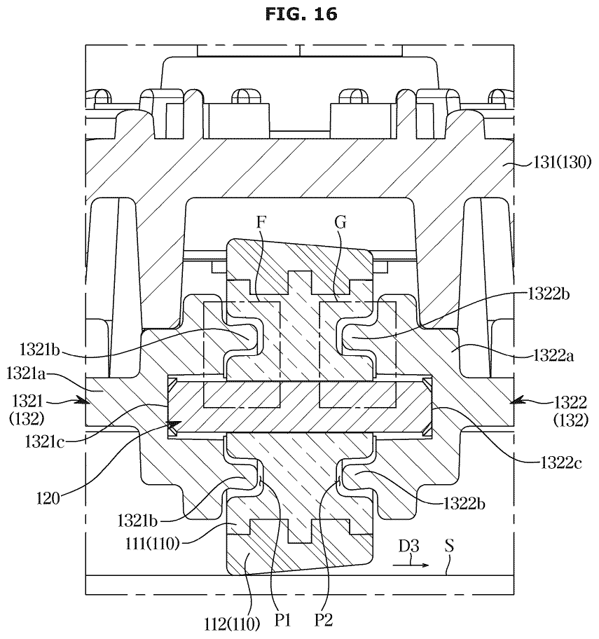

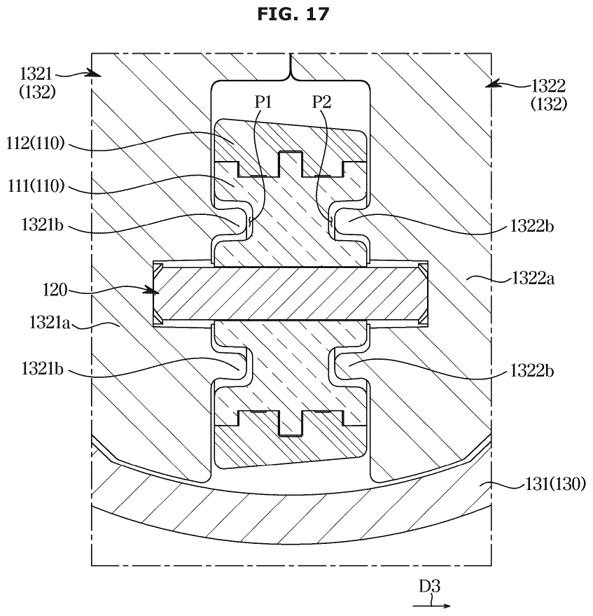

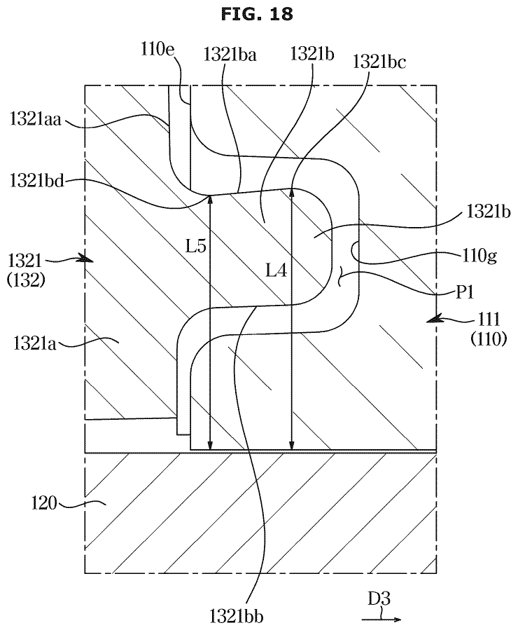

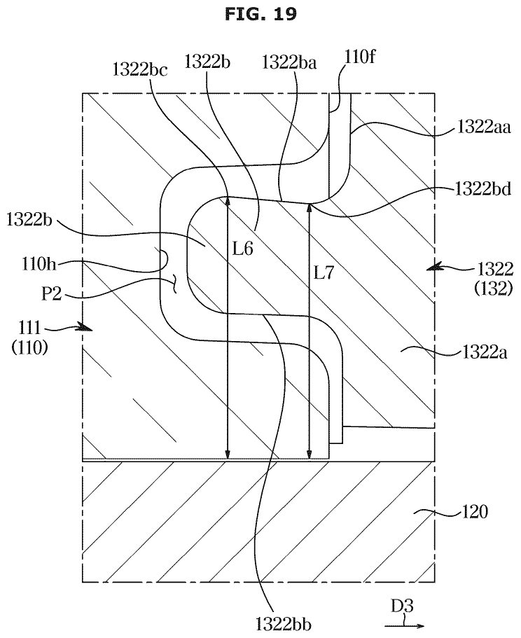

FIG. 16 is an enlarged view of a region D of FIG. 6. FIG. 17 is an enlarged view of a region E of FIG. 11. FIG. 18 is an enlarged view of a region F of FIG. 16. FIG. 19 is an enlarged view of a region G of FIG. 16.

Referring to FIGS. 16 to 19, the second wheel 110 may include a first side 110e, and a second side 110f. The first side 110e and the second side 110f of the second wheel 110 may be formed between the inner and outer circumferential surfaces of the second wheel 110, respectively. The first side 110e of the second wheel 110 may be provided on the opposite side of the second side

### 110f of the Second Wheel 110.

The first side 110e may include one side of the inner ring 111, and one side of the outer ring 112. The second side 110f may include the other side opposite the one side of the inner ring 111, and the other side opposite the one side of the outer ring 112. The first side 110e may face the first lower cover 1321. The second side 110f may face the second lower cover 1322.

The second wheel 110 may include a first groove portion 110g. The first groove portion 110g may be provided on the first side 110e of the second wheel 110. The first groove portion 110g may be recessed into the first side 110e of the second wheel 110. Particularly, the first groove portion 110g may be recessed into the one side of the inner ring 111.

The first groove portion 110g may extend along the circumferential direction of the second wheel 110. In other words, the first groove portion 110g may be provided along the circumferential direction of the second wheel 110. In other words, the first groove portion 110g may extend along the circumferential direction of the second wheel shaft 120. In other words, the first groove portion 110g may be provided along the circumferential direction of the second wheel shaft 120.

The first groove portion 110g may be formed spaced apart from the second wheel shaft 120. That is, the first groove portion 110g may extend along the circumferential direction of the second wheel 110 while being spaced apart from the second wheel shaft 120.

The first groove portion 110g may form a receiving space. The receiving space formed by the first groove portion 110g may extend along the circumferential direction of the second wheel 110. The receiving space formed by the first groove portion 110g may be provided along the circumferential direction of the second wheel 110. For example, the receiving space formed by the first groove portion 110g may have a substantially torus shape.

The second wheel 110 may include a second groove portion 110h. The second groove portion 110h may be provided on the second side 110f of the second wheel 110. The second groove portion 110h may be recessed in the second side 110f of the second wheel 110. That is, the second groove portion 110h may be provided on an opposite side of the first groove portion 110g. Particularly, the second groove portion 110h may be recessed in the other side of the inner ring 111.

The second groove portion 110h may extend along the circumferential direction of the second wheel 110. In other words, the second groove portion 110h may be provided along the circumferential direction of the second wheel 110. In other words, the second groove portion 110h may extend along the circumferential direction of the second wheel shaft 120. In other words, the second groove portion 110h may be provided along the circumferential direction of the second wheel shaft 120.

The second groove portion 110h may be formed spaced apart from the second wheel shaft 120. That is, the second groove portion 110h may extend along the circumferential direction of the second wheel 110 while being spaced apart from the second wheel shaft 120. A distance at which the second groove portion 110h is spaced apart from the second wheel shaft 120 may be the same as a distance at which the first groove portion 110g is spaced apart from the second wheel shaft 120. That is, the second groove portion 110h may be formed at a position corresponding to the first groove portion 110g.

The second groove portion 110h may form a receiving space. The receiving space formed by the second groove portion 110h may extend along the circumferential direction of the second wheel 110. The receiving space formed by the second groove portion 110h may be provided along the circumferential direction of the second wheel 110. For example, the receiving space formed by the second groove portion 110h may have a substantially ring shape.

The first lower cover 1321 may include a first lower cover body 1321a. The first lower cover body 1321a may form an overall appearance of the first lower cover 1321.

One side 1321a a of the first lower cover body 1321a may cover the second wheel 110. Particularly, the one side 1321aa of the first lower cover body 1321a may cover at least a portion of the first side 110e of the second wheel 110. Particularly, the one side 1321aa of the first lower cover body 1321a may cover one side of the inner ring 111 of the second wheel 110.

The one side 1321aa of the first lower cover body 1321a and the first side 110e of the second wheel 110 may be spaced apart from each other by a predetermined distance. With the configuration, the second wheel 110 may rotate smoothly without interference with the first lower cover body 1321a.

The first lower cover 1321 may include a first protrusion 1321b. The first protrusion 1321b may protrude from the first lower cover body 1321a. Particularly, the first protrusion 1321b may protrude from the first lower cover body 1321a toward the first groove portion 110g. Particularly, the first protrusion 1321b may protrude from the one side 1321aa of the first lower cover body 1321a.

The first protrusion 1321b may extend along the circumferential direction of the second wheel shaft 120. In other words, the first protrusion 1321b may be provided along the circumferential direction of the second wheel shaft 120. In other words, the first protrusion 1321b may extend along the circumferential direction of the second wheel 110. In other words, the first protrusion 1321b may be provided along the circumferential direction of the second wheel 110.

The first protrusion 1321b may be spaced apart from the second wheel shaft 120. That is, the first protrusion 1321b may extend along the circumferential direction of the second wheel 110 while being spaced apart from the second wheel shaft 120.

The first protrusion 1321b may be received inside the first groove portion 110g. In other words, the first protrusion 1321b may be received in the receiving space formed by the first groove portion 110g. In other words, the first protrusion 1321b may be inserted into the first groove portion 110g.

The first protrusion 1321b may be provided in a shape corresponding to the receiving space formed by the first groove portion 110g. For example, the first protrusion 1321b may be provided in a substantially ring shape.

The first protrusion 1321b may be spaced apart from the first groove portion 110g by a predetermined distance. With the configuration, the second wheel 110 may rotate smoothly without interference with the first lower cover body 1321a.

The first protrusion 1321b may include an outer surface 1321ba, and an inner surface 1321bb. The outer surface 1321ba of the first protrusion 1321b may be provided on an opposite side of the inner surface 1321bb of the first protrusion 1321b. Particularly, the outer surface 1321ba of the first protrusion 1321b may be provided on an outer side with respect to the radial direction of the second wheel shaft 120, and the inner surface 1321bb of the first protrusion 1321b may be provided on an inner side with respect to the radial direction of the second wheel shaft 120. In other words, the inner surface 1321bb of the first protrusion 1321b may be provided to be closer to the second wheel shaft 120 than the outer surface 1321ba of the first protrusion 1321b. The outer surface 1321ba and the inner surface 1321bb of the first protrusion 1321b may each extend in a direction in which the first protrusion 1321b protrudes.

The first protrusion 1321b may include a first end 1321bc. The first end 1321bc may be provided at one end of the first protrusion 1321b with respect to the direction in which the first protrusion 1321b protrudes. At this time, the first end 1321bc may be a portion that is furthest away from the one side 1321aa of the first lower cover body 1321a with respect to the direction in which the first protrusion 1321b protrudes.

The first end 1321bc may be formed on the outer surface 1321ba of the first protrusion 1321b. That is, the first end 1321bc may be formed on one end of the outer surface 1321ba of the first protrusion 1321b with respect to the direction in which the first protrusion 1321b protrudes.

The first protrusion 1321b may include a second end 1321bd. The second end 1321bd may be provided at the other end of the protrusion 1321ba with respect to the direction in which the first protrusion 1321b protrudes. At this time, the other end of the protrusion 1321ba may be provided on the opposite side of the one end of the protrusion 1321ba with respect to the direction in which the first protrusion 1321b protrudes. That is, the other end of the protrusion 1321ba may be a portion provided adjacent to the one side 1321aa of the first lower cover body 1321a.

The second end 1321bd may be formed on the outer surface 1321ba of the first protrusion 1321b. That is, the second end 1321bd may be a portion in which the outer surface 1321ba of the first protrusion 1321b and one side 1322aa of a second lower cover body 1322a come into contact with each other. The second end 1321bd may be provided on the opposite side of the first end 1321bc with respect to the direction in which the first protrusion 1321b protrudes.

The outer surface 1321ba of the first protrusion 1321b may extend from the second end 1321bd toward the first end 1321bc. In other words, the outer surface 1321ba of the first protrusion 1321b may extend from the second end 1321bd to the first end 1321bc.

A distance, at which at least a portion of the first protrusion 1321b provided between the first end 1321bc and the second end 1321bd is spaced apart from the second wheel shaft 120 with respect to the radial direction of the second wheel shaft 120, may be greater than a distance L5 at which the second end 1321bd is spaced apart from the second wheel shaft 120 with respect to the radial direction of the second wheel shaft 120. Particularly, a distance L4 at which the first end 1321bc is spaced apart from the second wheel shaft 120 with respect to the radial direction of the second wheel shaft 120 may be greater than the distance L5 at which the second end 1321bd is spaced apart from the second wheel shaft 120 with respect to the radial direction of the second wheel shaft 120. In other words, the first end 1321bc may be provided outside the second end 1321bd with respect to the radial direction of the second wheel shaft 120.

The outer surface 1321ba of the first protrusion 1321b may be inclined with respect to an extension direction of the second wheel shaft 120. In other words, the outer surface 1321ba of the first protrusion 1321b may be inclined with respect to the third direction D3. Particularly, the outer surface of the first protrusion 1321b may be extended inclined from the first end 1321bc toward the radial direction of the second wheel shaft 120.

The first lower cover 1321 may include a first wheel shaft receiving portion 1321c. The first wheel shaft receiving portion 1321c may be recessed in the one side 1321aa of the first lower cover body 1321a. The first wheel shaft receiving portion 1321c may form a receiving space for receiving one end of the second wheel shaft 120. As the one end of the second wheel shaft 120 is received in the first wheel shaft receiving portion 1321c, the first lower cover 1321 may support the one end of the second wheel shaft 120.

The first wheel shaft receiving portion 1321c may be provided on an inner side of the first protrusion 1321b. In other words, the first protrusion 1321b may be provided on an outside of the first wheel shaft receiving portion 1321c.

The second lower cover 1322 may include the second lower cover body 1322a. The second lower cover body 1322a may form an overall appearance of the second lower cover 1322.

The one side 1322aa of the second lower cover body 1322a may cover the second wheel 110. Particularly, the one side 1322aa of the second lower cover body 1322a may cover at least a portion of the second side 110f of the second wheel 110. Particularly, the one side 1322aa of the second lower cover body 1322a may cover one side of the inner ring 111 of the second wheel 110.

The one side of 1322aa of the second lower cover body 1322a and the second side 110f of the second wheel 110 may be spaced apart from each other by a predetermined distance. With the configuration, the second wheel 110 may rotate smoothly without interference with the second lower cover body 1322a.

The second lower cover 1322 may include a second protrusion 1322b. The second protrusion 1322b may protrude from the second lower cover body 1322a. Particularly, the second protrusion 1322b may protrude from the second lower cover body 1322a toward the second groove portion 110h. Particularly, the second protrusion 1322b may protrude from the one side 1322aa of the second lower cover body 1322a.

The second protrusion 1322b may extend along the circumferential direction of the second wheel shaft 120. In other words, the second protrusion 1322b may be provided along the circumferential direction of the second wheel shaft 120. In other words, the second protrusion 1322b may extend along the circumferential direction of the second wheel 110. In other words, the second protrusion 1322b may be provided along the circumferential direction of the second wheel 110.

The second protrusion 1322b may be spaced apart from the second wheel shaft 120. That is, the second protrusion 1322b may extend along the circumferential direction of the second wheel 110 while being spaced apart from the second wheel shaft 120. A distance at which the second protrusion 1322b is spaced apart from the second wheel shaft 120 may be the same as a distance at which the first protrusion 1321b is spaced apart from the second wheel shaft 120. That is, the second protrusion 1322b may be formed at a position corresponding to the first protrusion 1321b.

The second protrusion 1322b may be received inside the second groove portion 110h. In other words, the second protrusion 1322b may be received in the receiving space formed by the second groove portion 110h. In other words, the second protrusion 1322b may be inserted into the second groove portion 110h.

The second protrusion 1322b may be provided in a shape corresponding to the receiving space formed by the second groove portion 110h. For example, the second protrusion 1322b may be provided in a substantially torus shape.

The second protrusion 1322b may be spaced apart from the second groove portion 110h by a predetermined distance. With the configuration, the second wheel 110 may rotate smoothly without interference with the second lower cover body 1322a.

The second protrusion 1322b may include an outer surface 1322ba, and an inner surface 1322bb. The outer surface 1322ba of the second protrusion 1322b may be provided on an opposite side of the inner surface 1322bb of the second protrusion 1322b. Particularly, the outer surface 1322ba of the second protrusion 1322b may be provided on an outer side with respect to the radial direction of the second wheel shaft 120, and the inner surface 1322bb of the second protrusion 1322b may be provided on an inner side with respect to the radial direction of the second wheel shaft 120. In other words, the inner surface 1322bb of the second protrusion 1322b may be provided to be closer to the second wheel shaft 120 than the outer surface 1322ba of the second protrusion 1322b. The outer surface 1322ba and the inner surface 1322bb of the second protrusion 1322b may each extend in a direction in which the second protrusion 1322b protrudes.

The second protrusion 1322b may include a third end 1322bc. The third end 1322bc may be provided at one end of the second protrusion 1322b with respect to the direction in which the second protrusion 1322b protrudes. At this time, the third end 1322bc may be a portion that is furthest away from the one side 1322aa of the second lower cover body 1322a with respect to the direction in which the second protrusion 1322b protrudes.

The third end 1322bc may be formed on the outer surface 1322ba of the second protrusion 1322b. That is, the third end 1322bc may be formed on one end of the outer surface 1322ba of the second protrusion 1322b with respect to the direction in which the second protrusion 1322b protrudes.

The second protrusion 1322b may include a fourth end 1322bd. The fourth end 1322bd may be provided at the other end of the protrusion 1322ba with respect to the direction in which the second protrusion 1322b protrudes. At this time, the other end of the protrusion 1322ba may be provided on the opposite side of the one end of the protrusion 1322ba with respect to the direction in which the second protrusion 1322b protrudes. That is, the other end of the protrusion 1322ba may be a portion provided adjacent to the one side 1322aa of the second lower cover body 1322a.

The fourth end 1322bd may be formed on the outer surface 1322ba of the second protrusion 1322b. That is, the fourth end 1322bd may be a portion in which the outer surface 1322ba of the second protrusion 1322b and the one side 1322aa of the second lower cover body 1322a come into contact with each other. The fourth end 1322bd may be provided on the opposite side of the third end 1322bc with respect to the direction in which the second protrusion 1322b protrudes.

The outer surface 1322ba of the second protrusion 1322b may extend from the fourth end 1322bd toward the third end 1322bc. In other words, the outer surface 1322ba of the second protrusion 1322b may extend from the fourth end 1322bd to the third end 1322bc.

A distance at which at least a portion of the second protrusion 1322b provided between the third end 1322bc and the fourth end 1322bd is spaced apart from the second wheel shaft 120 with respect to the radial direction of the second wheel shaft 120 may be greater than a distance L7 at which the fourth end 1322bd is spaced apart from the second wheel shaft 120 with respect to the radial direction of the second wheel shaft 120. Particularly, a distance L6 at which the third end 1322bc is spaced apart from the second wheel shaft 120 with respect to the radial direction of the second wheel shaft 120 may be greater than the distance L7 at which the fourth end 1322bd is spaced apart from the second wheel shaft 120 with respect to the radial direction of the second wheel shaft 120. In other words, the third end 1322bc may be provided outside the fourth end 1322bd with respect to the radial direction of the second wheel shaft 120.

The outer surface 1322ba of the second protrusion 1322b may be inclined with respect to the extension direction of the second wheel shaft 120. In other words, the outer surface 1322ba of the second protrusion 1322b may be inclined with respect to the third direction D3. Particularly, the outer surface of the second protrusion 1322b may extend inclinedly from the fourth end 1322bd toward the radial direction of the second wheel shaft 120.

The second lower cover 1322 may include a second wheel shaft receiving portion 1322c. The second wheel shaft receiving portion 1322c may be recessed on the one side 1322aa of the second lower cover body 1322a. The second wheel shaft receiving portion 1322c may form a receiving space for receiving the other end of the second wheel shaft 120. As the other end of the second wheel shaft 120 is received in the second wheel shaft receiving portion 1322c, the second lower cover 1322 may support the other end of the second wheel shaft 120.

The second wheel shaft receiving portion 1322c may be provided on an inner side of the second protrusion 1322b. In other words, the second protrusion 1322b may be provided on an outside of the second wheel shaft receiving portion 1322c.

As described above, the one side 1321aa of the first lower cover body 1321a and the first side 110e of the second wheel 110 may be spaced apart from each other by a predetermined distance, and the first protrusion 1321b may be spaced apart from the first groove portion 110g by a predetermined distance. Accordingly, a first separation space P1 may be formed between the first lower cover 1321 and the second wheel 110.

The first separation space P1 may extend from the outside of the projector 1a to the first wheel shaft receiving portion 1321c. Therefore, foreign substances outside the projector 1a may be introduced into the first wheel shaft receiving portion 1321c through the first separation space P1. That is, the first separation space P1 may form an inflow path through which foreign substances outside the projector 1a are introduced into the inside of the second wheel 110. The first separation space P1 may also be referred to as a first inflow path P1.

In addition, the one side 1322aa of the second lower cover body 1322a and the second side 110f of the second wheel 110 may be spaced apart from each other by a predetermined distance, and the second protrusion 1322b may be spaced apart from the second groove portion 110h by a predetermined distance. Accordingly, a second separation space P2 may be formed between the second lower cover 1322 and the second wheel 110.

The second separation space P2 may extend from the outside of the projector 1a to the second wheel shaft receiving portion 1322c. Therefore, foreign substances outside the projector 1a may be introduced into the second wheel shaft receiving portion 1322c through the second separation space P2. That is, the second separation space P2 may form an inflow path through which foreign substances outside the projector 1a are introduced into the inside of the second wheel 110. The second separation space P2 may also be referred to as a second inflow path P2.

Foreign substances which are introduced through each inflow path P1 or P2 may rotate together with the second wheel 110. Accordingly, the foreign substances may move to the inflow paths P1 and P2 disposed on the upper side of the second wheel shaft 120. In this case, the foreign substances may move further downward due to their own weight, and there may be a greater possibility of foreign substances being introduced into the wheel shaft receiving portions 1321c and 1322c.

When foreign substances are introduced into the wheel shaft receiving portions 1321c and 1322c, the rotation of the second wheel 110 with respect to the second wheel shaft 120 may be restricted. That is, it is difficult for the second wheel 110 to smoothly rotate.

According to the present disclosure, because the lower cover bodies 1321a and 1322a include the protrusions 1321b and 1322b, and the second wheel 110 includes the groove portions 110g and 110h, each of the inflow paths P1 and P2 may not extend in one direction but may include a plurality of bending portions. Due to the configuration, it is possible to primarily prevent foreign substances outside the projector 1a from being introduced into the wheel shaft receiving portions 1321c and 1322c through the inflow paths P1 and P2. In other words, it is possible to primarily prevent foreign substances outside the projector 1a from being introduced into the second wheel 110 through the inflow paths P1 and P2.

Particularly, with respect to the radial direction of the second wheel shaft 120, the first end 1321bc may be provided outside the second end 1321bd, and the third end 1322bc may be provided outside the fourth end 1322bd. Due to the configuration, even when foreign substances move toward the inflow paths P1 and P2 disposed on the upper side of the second wheel shaft 120, it is possible to prevent the foreign substances from moving further downward caused by their own weight. For example, even when foreign substances move toward the second end 1321bd, the foreign substances may be restricted from falling downward beyond the first end 1321bc because the first end 1321bc is provided outside the radial direction of the second wheel shaft 120 than the second end 1321bd. Therefore, it is possible to secondarily prevent foreign substances outside the projector 1a from being introduced into the wheel shaft receiving portions 1321c and 1322c through the separation space. In other words, it is possible to secondarily prevent foreign substances outside the projector 1a from being introduced into the second wheel 110 through the separation space.

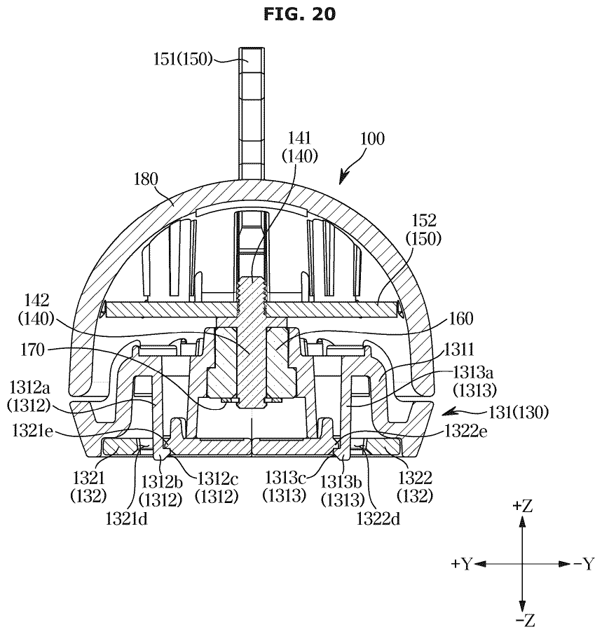

FIG. 20 is a cross-sectional view taken along line C-C′ of FIG. 3.

Referring to FIG. 20, the upper cover 131 may include an upper cover body 1311. The upper cover body 1311 may form an overall appearance of the upper cover 131.

The upper cover 131 may include a first hook 1312. The first hook 1312 may protrude downwardly from the upper cover body 1311. In other words, the first hook 1312 may protrude from the upper cover body 1311 toward the lower cover 132. Particularly, the first hook 1312 may protrude from the upper cover body 1311 toward the first lower cover 1321. Particularly, the first hook 1312 may protrude from the upper cover body 1311 toward a first cover opening 1321d to be described later.

The first hook 1312 may include a first hook body 1312a. The first hook body 1312a may extend downward from the upper cover body 1311. In other words, the first hook body 1312a may protrude downward from the upper cover body 1311. A lower end portion of the first hook body 1312a may penetrate the first cover opening 1321d.

The first hook 1312 may include a first hook protrusion 1312b. The first hook protrusion 1312b may protrude from a lower end portion of the first hook body 1312a. Particularly, the first hook protrusion 1312b may protrude from the lower end portion of the first hook body 1312a to a direction intersecting a direction in which the first hook body 1312a extends. Particularly, the first hook protrusion 1312b may protrude from the lower end portion of the first hook body 1312a to an inward direction of the second wheel device 100. For example, the first hook protrusion 1312b may protrude from the lower end portion of the first hook body 1312a toward the second lower cover 1322.

The first hook protrusion 1312b may be hooked to at least a portion of the first lower cover 1321. Particularly, the first hook protrusion 1312b may be hooked to a lower surface of the at least a portion of the first lower cover 1321. For example, the first hook protrusion 1312b may be hooked to a first locking protrusion 1321e to be described later.

The first hook protrusion 1312b may include a first inclined surface 1312c inclined upward from a lower end portion of the first hook protrusion 1312b. In other words, the first inclined surface 1312c that extends upwardly from the lower end portion of the first hook body 1312a may be provided on a lower surface of the first hook protrusion 1312b.

The upper cover 131 may include a second hook 1313. The second hook 1313 may protrude downwardly from the upper cover body 1311. In other words, the second hook 1313 may protrude from the upper cover body 1311 toward the lower cover 132. Particularly, the second hook 1313 may protrude from the upper cover body 1311 toward the second lower cover 1322. Particularly, the second hook 1313 may protrude from the upper cover body 1311 toward a second cover opening 1322d to be described later.

The second hook 1313 may include a second hook body 1313a. The second hook body 1313a may extend downward from the upper cover body 1311. In other words, the second hook body 1313a may protrude downward from the upper cover body 1311. A lower end portion of the second hook body 1313a may penetrate the second cover opening 1322d.

The second hook 1313 may include a second hook protrusion 1313b. The second hook protrusion 1313b may protrude from a lower end portion of the second hook body 1313a. Particularly, the second hook protrusion 1313b may protrude from the lower end portion of the second hook body 1313a to a direction intersecting a direction in which the second hook body 1313a extends. Particularly, the second hook protrusion 1313b may protrude from the lower end portion of the second hook body 1313a to an inward direction of the second wheel device 100. For example, the second hook protrusion 1313b may protrude from the lower end portion of the second hook body 1313a toward the first lower cover 1321.

The second hook protrusion 1313b may be hooked to at least a portion of the second lower cover 1322. Particularly, the second hook protrusion 1313b may be hooked to a lower surface of the at least a portion of the second lower cover 1322. For example, the second hook protrusion 1313b may be hooked to a second locking protrusion 1322e to be described later.

The second hook protrusion 1313b may include a second inclined surface 1313c inclined upward from a lower end portion of the second hook protrusion 1313b. In other words, the second inclined surface 1313c that extends upwardly from the lower end portion of the second hook body 1313a may be provided on a lower surface of the second hook protrusion 1313b.

The first lower cover 1321 may include the first cover opening 1321d. The first cover opening 1321d may be formed in the first lower cover body 1321a.

The first cover opening 1321d may be provided to allow at least a portion of the first hook 1312 to be inserted therein. In other words, at least a portion of the first hook 1312 may pass through the first cover opening 1321d. For example, the first hook protrusion 1312b may pass through the first cover opening 1321d.

The first lower cover 1321 may include the first locking protrusion 1321e. The first hook protrusion 1312b may be hooked to the first locking protrusion 1321e. As the first hook protrusion 1312b is hooked to the first locking protrusion 1321e, the first lower cover 1321 may be coupled to the upper cover 131.

The first locking protrusion 1321e may be formed on one side of the first cover opening 1321d. The first locking protrusion 1321e may be formed at a position corresponding to the first hook protrusion 1312b.

The first locking protrusion 1321e may be formed to be stepped on the lower surface of the first lower cover 1321. In other words, the first locking protrusion 1321e may be formed to be stepped on the lower surface of the first lower cover body 1321a. Particularly, the first locking protrusion 1321e may be formed to be higher than the lower surface of the first lower cover body 1321a.

The second lower cover 1322 may include the second cover opening 1322d. The second cover opening 1322d may be formed in the second lower cover body 1322a.

The second cover opening 1322d may be provided to allow at least a portion of the second hook 1313 to be inserted therein. In other words, at least a portion of the second hook 1313 may pass through the second cover opening 1322d. For example, the second hook protrusion 1313b may pass through the second cover opening 1322d.

The second lower cover 1322 may include the second locking protrusion 1322e. The second hook protrusion 1313b may be hooked to the second locking protrusion 1322e. As the second hook protrusion 1313b is hooked to the second locking protrusion 1322e, the second lower cover 1322 may be coupled to the upper cover 131.

The second locking protrusion 1322e may be formed on one side of the second cover opening 1322d. The second locking protrusion 1322e may be formed at a position corresponding to the second hook protrusion 1313b.

The second locking protrusion 1322e may be formed to be stepped on the lower surface of the second lower cover 1322. In other words, the second locking protrusion 1322e may be formed to be stepped on the lower surface of the second lower cover body 1322a. Particularly, the second locking protrusion 1322e may be formed to be higher than the lower surface of the second lower cover body 1322a.

According to the present disclosure, the first lower cover 1321 may be coupled to the upper cover 131 as the first hook protrusion 1312b is hooked to the first locking protrusion 1321e, and the second lower cover 1322 may be coupled to the upper cover 131 as the second hook protrusion 1313b is hooked to the second locking protrusion 1322e. At this time, as the first inclined surface 1312c of the first hook protrusion 1312b is pressed upward, the first hook protrusion 1312b may be separated from the first locking protrusion 1321e. As the second inclined surface 1313c of the second hook protrusion 1313b is pressed upward, the second hook protrusion 1313b may be separated from the second locking protrusion 1322e.

With the configuration, the lower covers 1321 and 1322 may be more easily separated from the upper cover 131. In addition, as the lower covers 1321 and 1322 are separated from the upper cover 131, the second wheel shaft 120 coupled to the wheel cover 130 and the second wheel 110 coupled to the second wheel shaft 120 may be separated. Accordingly, foreign substances being introduced into between the lower covers 1321 and 1322 and the upper cover 131, or foreign substances being introduced into the second wheel 110 may be more easily removed.

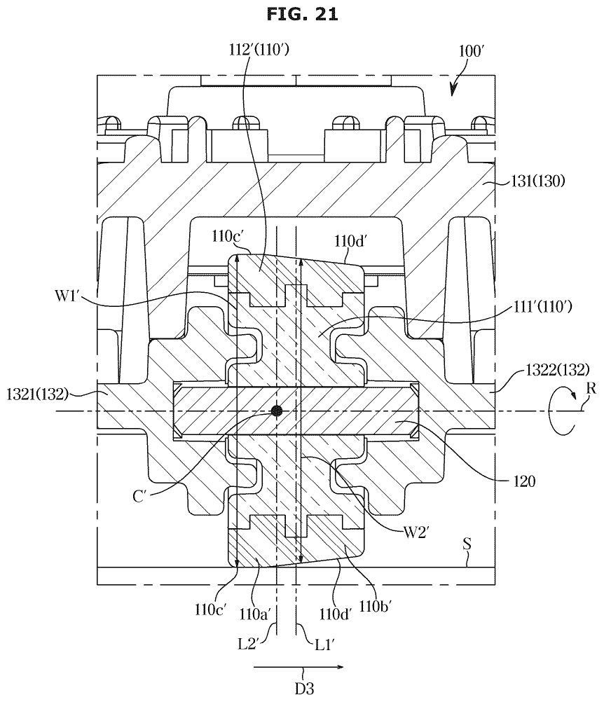

FIG. 21 is an enlarged cross-sectional view of a second wheel and a peripheral configuration thereof according to an embodiment.

Hereinafter a second wheel device 100′ according to an embodiment of the present disclosure will be described with reference to FIG. 21. In describing the second wheel device 100′, components that are substantially the same as those of FIGS. 1 to 20 are given the same reference numerals, and a detailed description thereof may be omitted.

Referring to FIG. 21, the second wheel device 100′ may include a second wheel 110′. The second wheel 110′ may include an inner ring 111 and an outer ring 112′.

The outer ring 112′ may be arranged on an outside of the inner ring 111. The outer ring 112′ may be coupled to an outside of the inner ring 111.

At least a portion of the outer ring 112′ may be provided to come into contact with the floor S on which the projector 1a is placed. For example, the outer ring 112′ may include a rubber material.

The second wheel 110′ may include an outer circumferential surface and an inner circumferential surface. The outer circumferential surface of the second wheel 110′ may refer to an outer surface of the second wheel 110′ with respect to a radial direction of the second wheel shaft 120, and the inner circumferential surface of the second wheel 110′ may refer to an inner surface of the second wheel 110′ with respect to the radial direction of the second wheel shaft 120. In addition, the outer circumferential surface of the second wheel 110′ may refer to an outer circumferential surface of the outer ring 112′, and the inner circumferential surface of the second wheel 110′ may refer to an inner circumferential surface of the inner ring 111.

The second wheel 110′ may include a first portion 110a′ and a second portion 110b′ that are distinguished based on a center of the second wheel 110′ with respect to the third direction D3. Particularly, the first portion 110a′ and the second portion 110b′ may be distinguished based on an imaginary line L1 that extends in the radial direction of the second wheel shaft 120 from the center of the second wheel 110′ with respect to the third direction D3. Accordingly, one end of the second wheel 110′ with respect to the third direction D3 may be provided in the first portion 110a′, and the other end of the second wheel 110′ with respect to the third direction D3 may be provided in the second portion 110b′.

An outer diameter of at least a portion of the first portion 110a′ may be greater than an outer diameter of the second portion 110b′. Particularly, the outer diameter of the at least a portion of the first portion 110a′ may be greater than an outer diameter W2′ provided to be the longest in the second portion 110b′. In other words, a distance at which an outer circumferential surface of the at least a portion of the first portion 110a′ is spaced apart from the second wheel shaft 120 with respect to the radial direction of the second wheel shaft 120 may be greater than a distance at which the outer circumferential surface of the second portion 110b′ is spaced apart from the second wheel shaft 120 with respect to the radial direction of the second wheel shaft 120.

The first portion 110a′ may include a contact portion 110c′ provided to come into contact with the floor S as the second wheel 110′ rotates. The contact portion 110c′ may be provided on the outer circumferential surface of the second wheel 110′.

An outer diameter W1′ measured at a portion where the contact portion 110c′ is provided may be greater than the outer diameter of the second portion 110b′. Particularly, the outer diameter W1′ measured at the portion where the contact portion 110c′ is provided may be greater than an outer diameter W2′ that is the longest in the second portion 110b′. In other words, a distance at which the contact portion 110c′ is spaced apart from the second wheel shaft 120 with respect to the radial direction of the second wheel shaft 120 may be greater than a distance at which the outer circumferential surface of the second portion 110b′ is spaced apart from the second wheel shaft 120 with respect to the radial direction of the second wheel shaft 120. With the configuration, a portion where the second wheel 110′ comes into contact with the floor S may be provided to be biased to one side with respect to the third direction D3.

The contact portion 110c′ may be formed along the circumferential direction of the second wheel 110. That is, the contact portion 110c′ may be an outer circumferential surface of a portion having the longest diameter in the second wheel 110.

The contact portion 110c′ may be provided on one end of the second wheel 110′ with respect to the third direction D3. Particularly, the contact portion 110c′ may be provided on an outer circumferential surface of one end of the second wheel 110′ with respect to the third direction D3.

An inclined portion 110d′ may be provided in an outer circumferential surface of at least a portion of the second wheel 110′. The inclined portion 110d′ may extend from the contact portion 110c′ toward the second portion 110b′. In other words, the contact portion 110c′ may be formed on one side of the inclined portion 110d′.

The inclined portion 110d′ may extend in an inclined direction with respect to the second wheel shaft 120′. That is, the inclined portion 110d′ may be inclined in a direction opposite to the radial direction of the second wheel shaft 120′. In other words, the inclined portion 110d′ may be inclined in a direction approaching the second wheel shaft 120′ from the contact portion 110c′. The inclined portion 110d′ may extend to the other end of the second wheel 110′ with respect to the third direction D3.

The contact portion 110c′ may be provided to extend in a direction in which the second wheel shaft 120 extends. That is, the contact portion 110c′ may be provided to extend in the third direction D3.

Particularly, the contact portion 110c′ may extend in the third direction D3 until the contact portion 110c′ comes into contact with an imaginary line L2′ extending in the radial direction of the second wheel shaft 120 from a center of gravity C′ of the second wheel 110′. In other words, the imaginary line L2′ extending in the radial direction of the second wheel shaft 120 from the center of gravity C′ of the second wheel 110′ may intersect the inclined portion 110d′ rather than the contact portion 110c′.

The inclined portion 110d′ may be spaced apart from the floor S and may be provided in the radial direction of the second wheel shaft 120 from the center of gravity C′ of the second wheel 110′. Accordingly, the second wheel 110′ may be slightly inclined toward the inclined portion 110d′.

FIG. 22 is a perspective view of a robot cleaner according to an embodiment. FIG. 23 is a bottom perspective view of the robot cleaner of FIG. 22.

Hereinafter a robot cleaner 1b according to an embodiment of the present disclosure will be described with reference to FIGS. 22 and 23. In describing the robot cleaner 1b, components that are substantially the same as those illustrated in FIGS. 1 to 20 are given the same reference numerals, and a detailed description thereof may be omitted.

Referring to FIGS. 22 and 23, the robot cleaner 1b may include a main body 10″. The main body 10″ may form an exterior of the robot cleaner 1b.

Components of the robot cleaner 1b may be received inside the main body 10″. For example, electrical components may be disposed inside the main body 10″.

The main body 10″ may include a suction port 210. The suction port 210 may be provided at a lower portion of the main body 10″. The suction port 210 may be formed to face a surface to be cleaned. The suction port 210 may be open toward the surface to be cleaned. Dirt on the surface to be cleaned may be drawn into the inside of the main body 10″ through the suction port 210 together with air.

The main body 10″ may include a brush 220. The brush 220 may be provided at the lower portion of the main body 10″. The brush 220 may be formed at the front side of the suction port 210. The brush 220 may strike the surface to be cleaned to scatter dirt. The dirt scattered by the brush 220 may be introduced into the suction port 210 together with air.

The main body 10″ may include a dust collector. Dirt and/or air drawn through the suction port 210 may move to the dust collector. Dirt drawn through the suction port 210 may be collected in the dust collector.

The robot cleaner 1b may include a first wheel device 20″. The first wheel device 20″ may be configured to move the main body 10″. The first wheel device 20″ may be provided to support the main body 10″. That is, the first wheel device 20″ may movably support the main body 10″. With the configuration, the robot cleaner 1b may be configured to be movable on a surface to be cleaned. The first wheel device 20″ may be provided at the lower portion of the main body 10″. The first wheel device 20″ may also be referred to as a main wheel device 20″.

The first wheel device 20″ may be provided in plurality. For example, two first wheel device 20″ may be provided. One of the two first wheel devices 20″ may be provided at a lower portion of one side of the main body 10″, and the other thereof may be provided at a lower portion of the other side of the main body 10″. Particularly, one of the two first wheel devices 20″ may be provided at a lower portion of the left side (+Y) of the main body 10″, and the other thereof may be provided at a lower portion of the right side (−Y) of the main body 10″.

The first wheel device 20″ may include a first wheel 21″. The first wheel 21″ may configured to be rotatable. Particularly, the first wheel 21″ may be rotatable with respect to a first rotation axis extending in a first direction. Particularly, the first wheel 21″ may be rotatable with respect to the main body 10″. The first wheel 21″ may be provided at the lower portion of the main body 10″. The first wheel 21″ may also be referred to as a main wheel 21″.

As the first wheel 21″ rotates, the main body 10″ may move or change a driving direction thereof. In other words, as the first wheel 21″ rotates, the robot cleaner 1b may move or change the driving direction thereof.

As described above, the first wheel device 20″ may be provided in plurality, and thus the first wheel 21″ may also be provided in plurality. For example, two first wheels 21″ may be provided. One of the two first wheels 21″ may be provided at a lower portion of one side of the main body 10″, and the other thereof may be provided at a lower portion of the other side of the main body 10″. Particularly, one of the two first wheels 21″ may be provided at the lower portion of the left side (+Y) of the main body 10″, and the other thereof may be provided at the lower portion of the right side (−Y) of the main body 10″.

The main body 10″ may include a driving device. The driving device may include a power source for transmitting power to another component. For example, the driving device may include a motor. The first wheel 21″ may be configured to rotate by the driving device.

The robot cleaner 1b may include a second wheel device 100″. The second wheel device 100″ may be configured to move the main body 10″. The second wheel device 100″ may be provided to support the main body 10″. That is, the second wheel device 100″ may movably support the main body 10″. Particularly, the second wheel device 100″ may support the main body 10″ so as to be movable together with the first wheel device 20″. With the configuration, the robot cleaner 1b may be configured to be movable on a surface to be cleaned. The second wheel device 100″ may also be referred to as an auxiliary wheel device 20″.

The second wheel device 100″ may be provided at the lower portion of the main body 10″. The second wheel device 100″ may be provided in front of the first wheel device 20″.

In the drawing, it is illustrated that a single second wheel device 100″ is provided, but there is no particular limitation on the number of second wheel devices 100″. For example, two or more second wheel devices 100″ may be provided.

The second wheel device 100″ may include a second wheel 110″. The second wheel 110″ may be configured to be rotatable.

The second wheel 110″ may be configured to rotate as the main body 10″ moves. In other words, the second wheel 110″ may rotate without a separate driving device to which the second wheel 110″ is directly coupled. That is, the driving direction or driving speed of the main body 10″ may be determined by the first wheel 21″ that rotates by the driving device. The second wheel 110″ may perform a function of assisting the first wheel 21″ to allow the main body 10″ to move smoothly. Therefore, the second wheel 110″ may be referred to as an auxiliary wheel 110″.

The second wheel device 100″ may include a wheel cover 130″. The wheel cover 130″ may be provided to cover at least a portion of the second wheel 110″.

The wheel cover 130″ may be configured to be rotatable. Particularly, the wheel cover 130″ may be rotatable with respect to the main body 10″.

The wheel cover 130″ may be rotatable with respect to a second rotation axis extending in a second direction intersecting the first rotation axis, which is the center of rotation of the first wheel 21″. In other words, the wheel cover 130″ may be rotatable with respect to the second rotation axis extending in the second direction intersecting the first direction.

The second wheel 110″ may be rotatable with respect to the wheel cover 130″. The second wheel 110″ may be rotatable with respect to a third rotation axis extending in a third direction intersecting the second rotation axis, which is the center of rotation of the wheel cover 130″. In other words, the second wheel 110″ may be rotatable with respect to the third rotation axis extending in the third direction intersecting the second direction.

That is, the wheel cover 130″ may rotate with respect to the main body 10″, and the second wheel 110′ may rotate with respect to the wheel cover 130″.

A specific configuration of the second wheel device 100″, a structure of the second wheel 110, and the like are substantially the same as the configuration of the second wheel device 100, the structure of the second wheel 110, and the like, illustrated in FIGS. 1 to 20. Therefore, detailed descriptions thereof are omitted.

The electronic device 1 according to an embodiment includes the main body 10, the first wheel device 20 configured to move the main body, and including the first wheel 21 rotatable with respect to the first rotation axis R1, and the second wheel device 100 configured to movably support the main body 10. The second wheel device 100 includes the wheel cover 130 rotatable relative to the main body 10 with respect to the second rotation axis R2 extending in a direction intersecting the first rotation axis R1, the wheel shaft 120 connected to the wheel cover 130 and extending in one direction D3 intersecting the second rotation axis R2, and the second wheel 110 rotatable relative to the central axis of the wheel shaft 120, and including the first portion 110a and the second portion 110b distinguished based on the imaginary line L1 extending in the radial direction of the wheel shaft 120 and aligned with the center of the second wheel 110 with respect to the one direction D3. The outer diameter of at least a portion of the first portion 110a is greater than the outer diameter of any portion of the second portion 110b.

The electronic device 1 may be configured to be movable on the floor S. An outer circumferential surface of at least a portion of the second wheel 110 may be provided to come into contact with the floor S as the second wheel 110 rotates.

The first portion 110a may include the contact portion 110c provided to come into contact with the floor S as the second wheel 110 rotates. A distance at which the contact portion 110c is spaced apart from the wheel shaft 120 may be greater than a distance at which an outer circumferential surface of the second portion 110b is spaced apart from the wheel shaft 120.

The inclined portion 110d extending from the contact portion 110c toward the second portion 110b and being inclined with respect to the wheel shaft 120 may be provided in the outer circumferential surface of the second wheel 110.

A first end of the second wheel 110 with respect to the one direction D3 may be provided in the first portion 110a. A second end of the second wheel 110 with respect to the one direction D3 may be provided in the second portion 110b. The inclined portion 110d may extend to the second end of the second wheel 110 with respect to the one direction D3.

The contact portion 110c may be provided at the first end of the second wheel 110.

The inclined portion 110d may be aligned with the center of gravity C of the second wheel 110 along the radial direction of the wheel shaft.

The second wheel device 100 may further include the coupling bracket 150 on the upper side of the wheel cover 130 and coupled to the main body 10, and the connecting shaft 140 penetrating the first through-hole 152b of the coupling bracket 150 and the second through-hole 131a of the wheel cover 130 so as to connect the coupling bracket 150 and the wheel cover 130. The central axis of the connecting shaft 140 may form the second rotation axis R2.

The coupling bracket 150 may be limited in rotation relative to the connecting shaft 140. The wheel cover 130 may be rotatable relative to the connecting shaft 140.

The wheel shaft 120 may be offset from the central axis of the connecting shaft 140.

The wheel cover 130 may include the upper cover 131 covering the upper portion of the second wheel 110, and the lower cover 132 coupled to the lower side of the upper cover 131 and supporting the wheel shaft 120.

The lower cover 132 may include the first lower cover 1321 supporting a first end of the wheel shaft 120, and the second lower cover 1322 supporting a second end of the wheel shaft 120.

The upper cover 131 may include the upper cover body 1311, and the hook 1312 protruding downward from the upper cover body 1311. The lower cover 132 may include the cover openings 1321d and 1322d into which the hook is inserted.

The hook may include the hook body 1312a extending downward from the upper cover body 1311, and the hook protrusion 1312b protruding from the lower end portion of the hook body 1312a in a direction intersecting a direction in which the hook body 1312a extends. The hook protrusion 1312b may include the inclined surface 1312c upwardly inclined from the lower end portion of the hook protrusion 1312b.

The electronic device 1 further comprises a driving device 12 comprising a motor. The driving device 12 is configured to rotate the first wheel 21. The second wheel 110 may be configured to rotate as the main body 10 moves.

The electronic device 1 according to an embodiment includes a main body 10, a first wheel 21 rotatably attached to the main body 10, wherein the first wheel 21 is rotatable around a first rotation axis R1, and a second wheel device 100 rotatably attached to the main body 10, the second wheel device 100 including: a wheel cover 130 rotatably connected to the main body 10 and configured to rotate around a second rotation axis R2, wherein the second rotation axis R2 extends in a direction intersecting a direction corresponding to the first rotation axis R1, a wheel shaft 120 attached to the wheel cover 130 and extending in a direction that intersects with the direction in which the second rotation axis R2 extends, and a second wheel 110 rotatably attached to the wheel shaft, wherein the second wheel 110 includes a circumferential outer surface including a first portion 110a and a second portion 110b, wherein an outer diameter of at least a portion of the first portion 110a is greater than an outer diameter of any portion of the second portion 110b.

The first portion 110a may include a contact portion 110c configured to come into contact with a floor S as the second wheel 110 rotates, and the contact portion 110c may be farther from the wheel shaft 120 than the second portion 110b.

At least a portion of the circumferential outer surface may be inclined in a direction corresponding to the second rotation axis R2.

The second wheel 110 may include a truncated cone.

The circumferential outer surface may include an inclined portion 110d extending from the contact portion 110c toward the second portion 110b.

As is apparent from the above description, an inclined portion may be provided on an outer circumferential surface of an auxiliary wheel, and thus the auxiliary wheel may be inclined toward one direction. Accordingly, responsiveness of the auxiliary wheel may become relatively faster according to the change in a driving direction of a main wheel.

Further, a first end may be provided on an outside than a second end, and a third end may be provided on an outside than a fourth end with respect to a radial direction of a second wheel shaft. Accordingly, foreign substances may be prevented from being introduced into an inside of an auxiliary wheel.

Further, an upper cover and a lower cover of an auxiliary wheel cover may be coupled through a hook, and an inclined surface may be provided on a lower end portion of a hook protrusion. With the configuration, it is possible to more easily separate the lower cover from the upper cover, and it is possible to more easily separate an auxiliary wheel and an auxiliary wheel shaft from the auxiliary wheel cover. Accordingly, a user can more easily remove foreign substances that are introduced into the inside of the auxiliary wheel.

While the present disclosure has been particularly described with reference to exemplary embodiments, it should be understood by those of skilled in the art that various changes in form and details may be made without departing from the spirit and scope of the present disclosure.

What is claimed is:

1. An electronic device comprising:
a main body;
a first wheel device configured to move the main body, the first wheel device comprising a first wheel rotatable with respect to a first rotation axis; and
a second wheel device configured to movably support the main body, the second wheel device comprising:
a wheel cover rotatable relative to the main body with respect to a second rotation axis, the second rotation axis extending in a direction intersecting the first rotation axis;
a wheel shaft connected to the wheel cover and extending in one direction intersecting the second rotation axis; and
a second wheel rotatable relative to a central axis of the wheel shaft, the second wheel comprising a first portion and a second portion distinguished based on an imaginary line extending in a radial direction of the wheel shaft and aligned with a center of the second wheel with respect to the one direction,
wherein an outer diameter of at least a portion of the first portion is greater than an outer diameter of any portion of the second portion.

2. The electronic device of claim 1, wherein the electronic device is configured to be movable on a floor, and
wherein an outer circumferential surface of at least a portion of the second wheel is provided to come into contact with the floor as the second wheel rotates.

3. The electronic device of claim 2, wherein the first portion comprises a contact portion configured to come into contact with the floor as the second wheel rotates, and
wherein a distance at which the contact portion is spaced apart from the wheel shaft is greater than a distance at which an outer circumferential surface of the second portion is spaced apart from the wheel shaft.

4. The electronic device of claim 3, wherein an inclined portion extending from the contact portion toward the second portion and being inclined with respect to the wheel shaft is provided in an outer circumferential surface of the second wheel.

5. The electronic device of claim 4, wherein a first end of the second wheel with respect to the one direction is provided in the first portion, and a second end of the second wheel with respect to the one direction is provided in the second portion, and
wherein the inclined portion extends to the second end of the second wheel with respect to the one direction.

6. The electronic device of claim 5, wherein the contact portion is provided at the first end of the second wheel.

7. The electronic device of claim 4, wherein the inclined portion is aligned with a center of gravity of the second wheel along the radial direction of the wheel shaft.

8. The electronic device of claim 1, wherein the second wheel device further comprises:
a coupling bracket on an upper side of the wheel cover and coupled to the main body; and
a connecting shaft penetrating a first through-hole of the coupling bracket and a second through-hole of the wheel cover so as to connect the coupling bracket and the wheel cover, and
wherein a central axis of the connecting shaft forms the second rotation axis.

9. The electronic device of claim 8, wherein the coupling bracket is limited in rotation relative to the connecting shaft, and the wheel cover is rotatable relative to the connecting shaft.

10. The electronic device of claim 9, wherein the wheel shaft is offset from the central axis of the connecting shaft.

11. The electronic device of claim 1, wherein the wheel cover comprises:
an upper cover covering an upper portion of the second wheel; and
a lower cover coupled to a lower side of the upper cover and supporting the wheel shaft.

12. The electronic device of claim 11, wherein the lower cover comprises:
a first lower cover supporting a first end of the wheel shaft; and
a second lower cover supporting a second end of the wheel shaft.

13. The electronic device of claim 11, wherein the upper cover comprises:
an upper cover body; and
a hook protruding downward from the upper cover body, and
wherein the lower cover comprises a cover opening into which the hook is inserted.

14. The electronic device of claim 13, wherein the hook comprises:
a hook body extending downward from the upper cover body; and
a hook protrusion protruding from a lower end portion of the hook body in a direction intersecting a direction in which the hook body extends, and
wherein the hook protrusion comprises an inclined surface upwardly inclined from a lower end portion of the hook protrusion.

15. The electronic device of claim 1, further comprising a driving device comprising a motor,
wherein the driving device is configured to rotate the first wheel, and the second wheel is configured to rotate as the main body moves.

16. An electronic device comprising:
a main body;
a first wheel rotatably attached to the main body, wherein the first wheel is rotatable around a first rotation axis; and
a second wheel device rotatably attached to the main body, the second wheel device comprising:
a wheel cover rotatably connected to the main body and configured to rotate around a second rotation axis, wherein the second rotation axis extends in a direction intersecting a direction corresponding to the first rotation axis;
a wheel shaft attached to the wheel cover and extending in a direction that intersects with the direction in which the second rotation axis extends; and
a second wheel rotatably attached to the wheel shaft,
wherein the second wheel comprises a circumferential outer surface comprising a first portion and a second portion,
wherein an outer diameter of at least a portion of the first portion is greater than an outer diameter of any portion of the second portion.

17. The electronic device of claim 16, wherein the first portion comprises a contact portion configured to come into contact with a floor as the second wheel rotates, and
wherein the contact portion is farther from the wheel shaft than the second portion.

18. The electronic device of claim 16, wherein at least a portion of the circumferential outer surface is inclined in a direction corresponding to the second rotation axis.

19. The electronic device of claim 16, wherein the second wheel comprises a truncated cone.

20. The electronic device of claim 17, wherein the circumferential outer surface comprises an inclined portion extending from the contact portion toward the second portion.
